(19) United States
(12) Patent Application Publication
(10) Pub. No.: US 2017/0269357 A1
(43) Pub. Date: Sep. 21, 2017

(54) STEREOSCOPIC DISPLAY DEVICE

(71) Applicant: Sharp Kabushiki Kaisha, Osaka (JP)

(72) Inventors: Takehiro MURAO, Sakai City (JP); Ryoh KIKUCHI, Sakai City (JP)

(21) Appl. No.: 15/532,175

(22) PCT Filed: Nov. 26, 2015
(86) PCT No.: PCT/JP2015/083279

§ 371 Date: Jun. 1, 2017

(30) Foreign Application Priority Data
Dec. 2, 2014 (JP) 2014-244444

(51) Int. Cl. G02B 27/00; G02F 1/1345; G02F 1/1343; G02B 27/22; G09G 3/36

(52) U.S. Cl. CPC G02B 27/0093; G02B 27/2214; G09G 3/36; G02F 1/134336; G02F 1/13454; G09G 2320/0209; G09G 2300/023; G09G 2300/0404

(57) ABSTRACT

Provided is a configuration of a stereoscopic display device that is capable of performing stereoscopic display in a plurality of orientations and reducing crosstalk. A stereoscopic display device (1) includes a display panel (10), a switching liquid crystal panel (20), a position sensor that acquires position information of a viewer, and a control device. The switching liquid crystal panel (20) includes a first substrate (21) and a second substrate (22); a liquid crystal layer; a plurality of first electrodes (211) arranged along a first direction at first intervals (BP1); a plurality of auxiliary electrodes (212) arranged along the first direction at the first intervals (BP1); an insulating film; and a plurality of second electrode (221) arranged along a second direction that intersects with the first direction at second intervals (BP2). The auxiliary electrodes (221) are arranged between the first electrodes (211), when viewed in a plan view. The control device includes a driving circuit that controls potentials of the first electrodes (211), the second electrodes (212), and the auxiliary electrodes (221), based on the position information.

### TECHNICAL FIELD

The present invention relates to a stereoscopic display device.

### BACKGROUND ART

As a stereoscopic display device that can be viewed with naked eyes, those of a parallax barrier type and a lenticular lens type are known. The naked eye stereoscopic display device has problems of a decrease in the resolution during stereoscopic display (3D display), a decrease in the brightness, and a narrow viewing range.

As a configuration that prevents the decrease in the resolution during 3D display, for example, JP-A-2009-9081 proposes an electronic video image device that is capable of providing stereoscopic video images of high resolution and good quality by using barriers. Even with this configuration, however, the narrow viewing range during 3D display cannot be solved.

As a technique for minimizing the decrease in the resolution and expanding the viewing range during 3D display, the eye tracking method is known wherein the positions of the eyes are recognized by a camera or the like, and right and left images are appropriately delivered according to the positions of the eyes.

The barrier division switching liquid crystal type and the polarization switching liquid crystal lens type are known as a device that is switchable between the two-dimensional display (2D display) and the 3D display, and expanding the viewing range during 3D display by tracking. The latter, however, requires three liquid crystal panels, and is therefore disadvantageous from the viewpoints of the thickness, costs and the like. The former, therefore, is promising, particularly for the portable device use.

On the other hand, for a portable device, a stereoscopic display device has been proposed that is capable of performing 3D display in both of the case where the display region is arranged in portrait orientation and the case where the display region is arranged in landscape orientation (hereinafter such a device is referred to as a “stereoscopic display device that can perform portrait/landscape 3D display”).

### SUMMARY OF THE INVENTION

No device of the barrier division switching liquid crystal type compatible with tracking, however, is realized as a stereoscopic display device that can perform portrait/landscape 3D display.

In order to realize smooth tracking, it is preferable to divide electrodes for forming barriers, as finely as possible. Besides, in order to enable 3D display in both of the portrait and landscape orientations, it is necessary to arrange electrodes in the portrait and landscape directions. For this reason, if it is intended to make the device compatible with tracking and capable of performing 3D display in both of the portrait orientation and the landscape orientation, the number of electrodes increases. If the number of electrodes increases, the area of clearances between electrodes increase relatively, which causes the performance of barriers to degrade, thereby leading to the increase of crosstalk.

It is an object of the present invention to achieve a configuration of a stereoscopic display device that is capable of performing stereoscopic display in a plurality of orientations and reducing crosstalk.

A stereoscopic display device disclosed herein includes a display panel; a switching liquid crystal panel that is arranged so as to be stacked on the display panel; a position sensor that acquires position information of a viewer; and a control device that controls the switching liquid crystal panel. The switching liquid crystal panel includes: a first substrate and a second substrate that are arranged so as to be opposed to each other; a liquid crystal layer interposed between the first substrate and the second substrate; a plurality of first electrodes formed on the first substrate, arranged along a first direction at first intervals; a plurality of auxiliary electrodes formed on the first substrate, arranged along the first direction at the first intervals; an insulating film that insulates the first electrodes and the auxiliary electrodes from each other; and a plurality of second electrodes formed on the second substrate, arranged along a second direction that intersects with the first direction at second intervals. The auxiliary electrodes are arranged between the first electrodes, when viewed in a plan view. The control device includes a driving circuit that controls potentials of the first electrodes, the second electrodes, and the auxiliary electrodes, based on the position information.

With the present invention, a stereoscopic display device that is capable of performing stereoscopic display in a plurality of orientations and reducing crosstalk can be obtained.

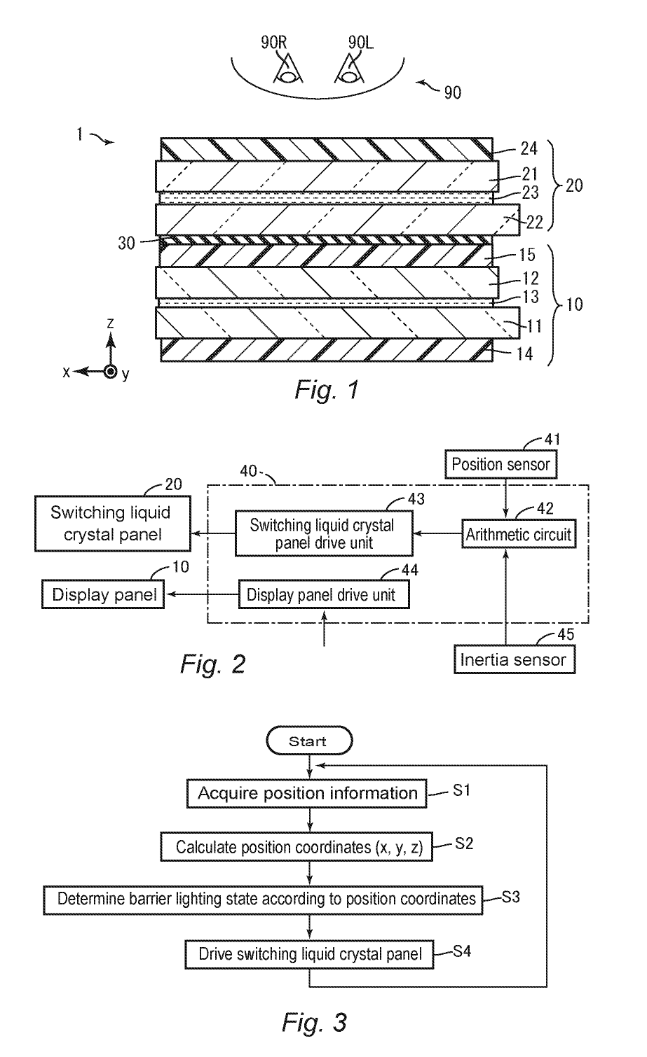

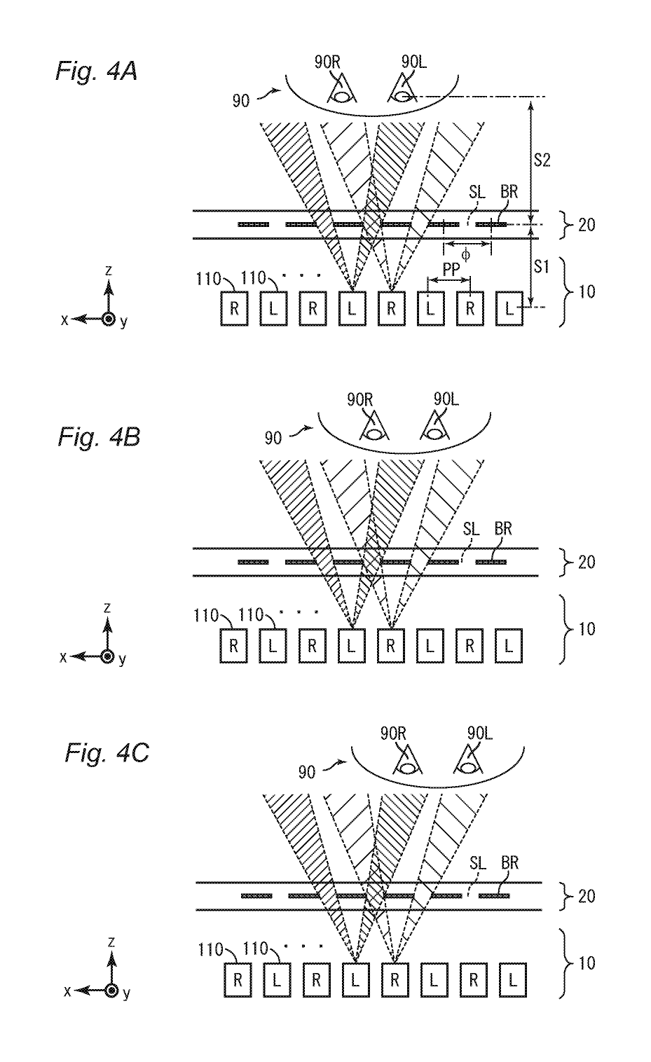

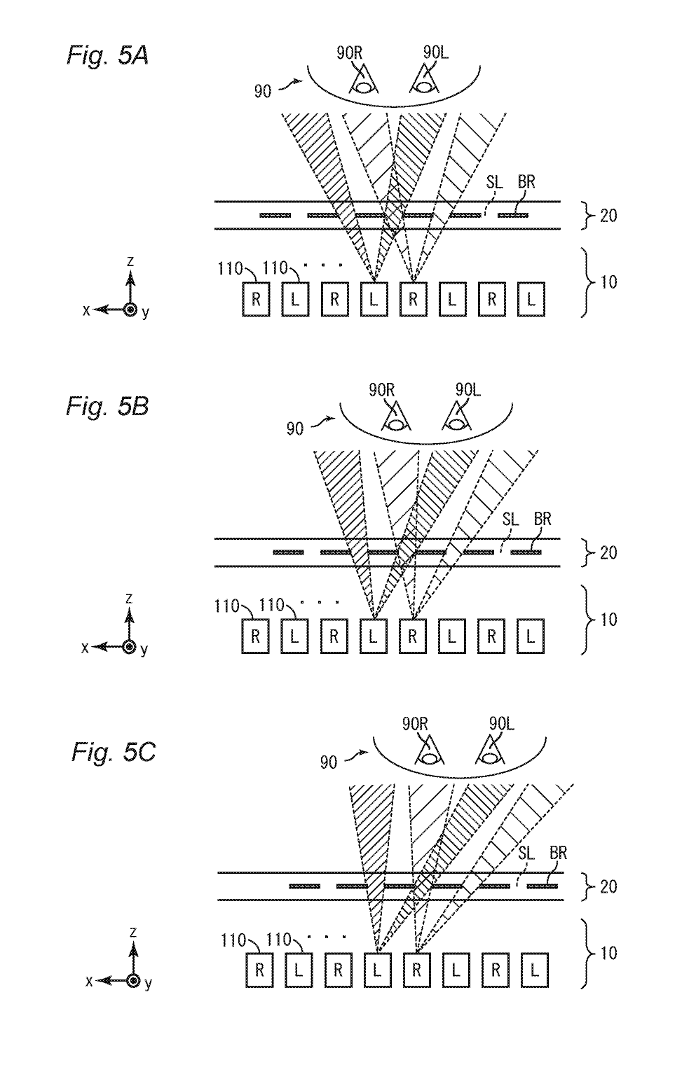

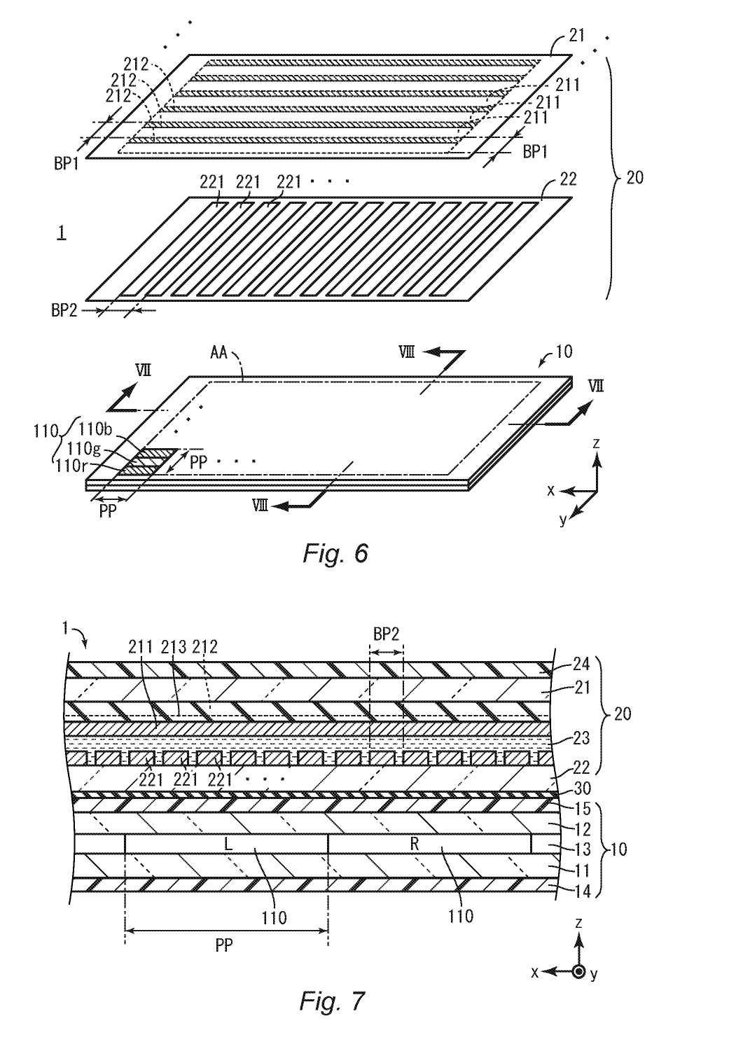

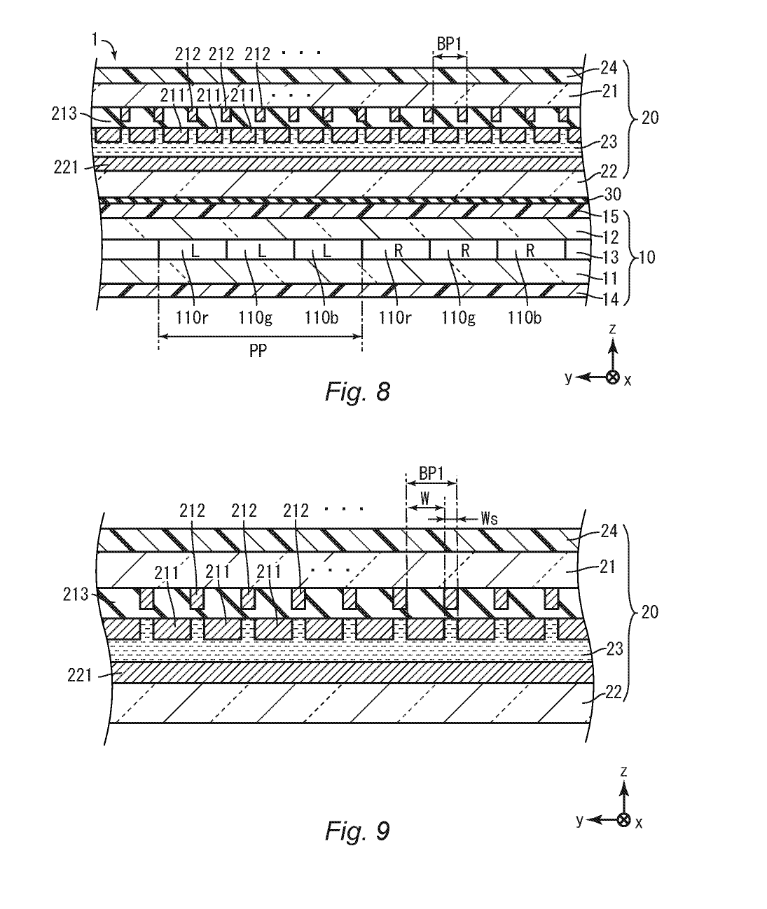

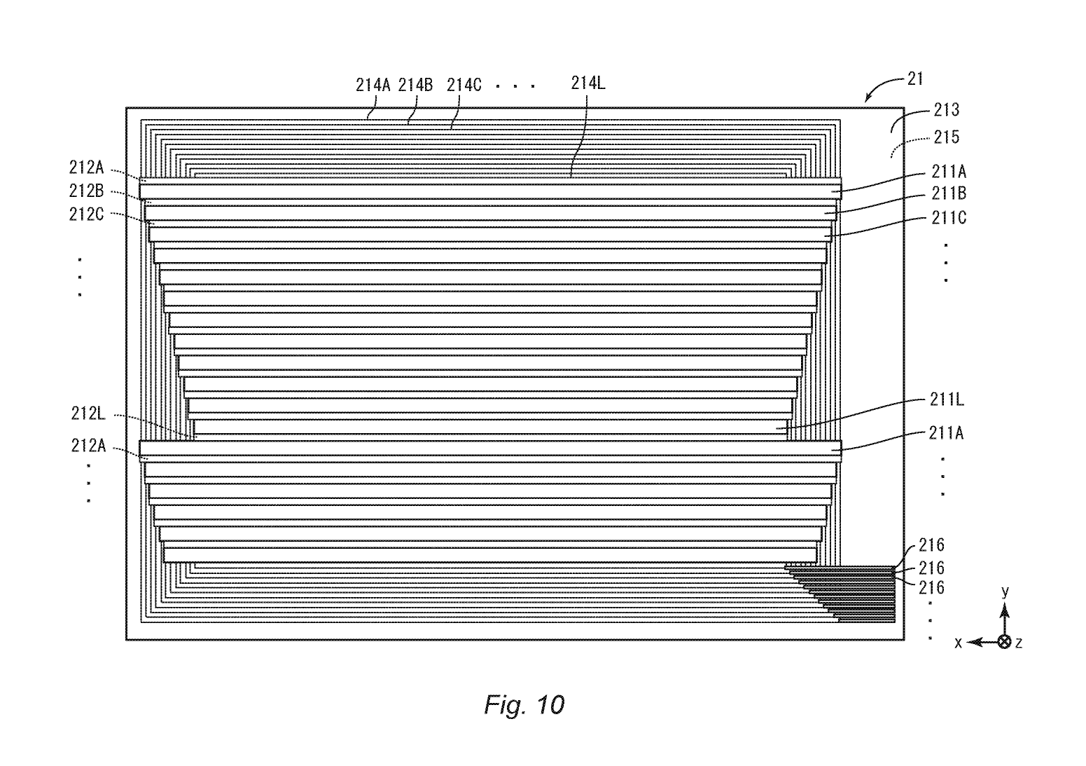

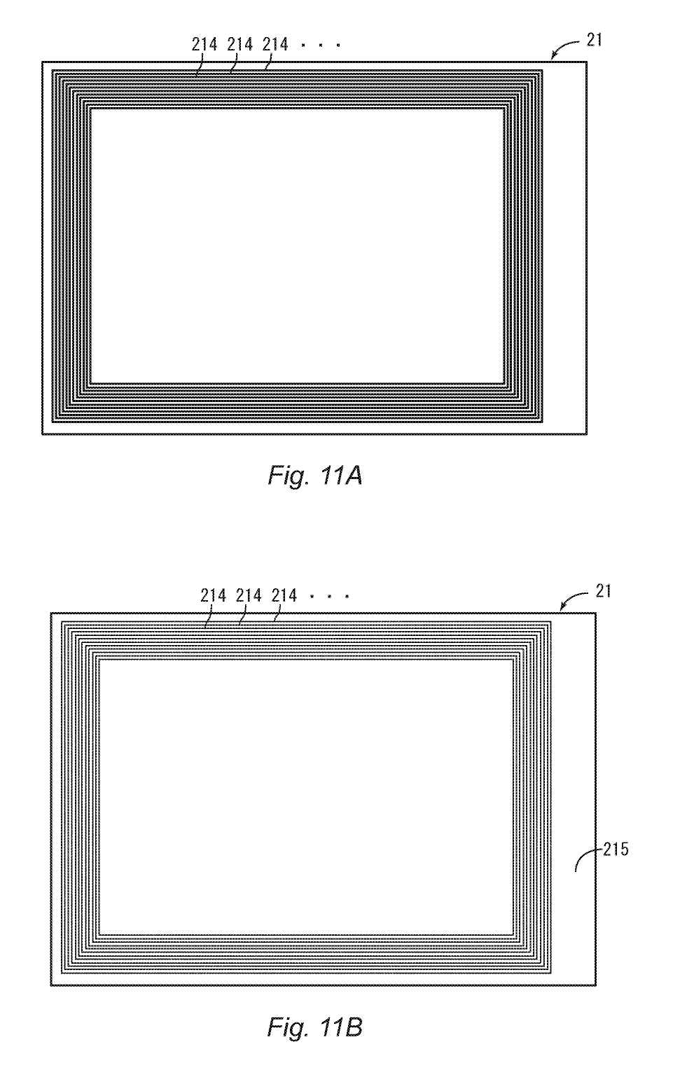

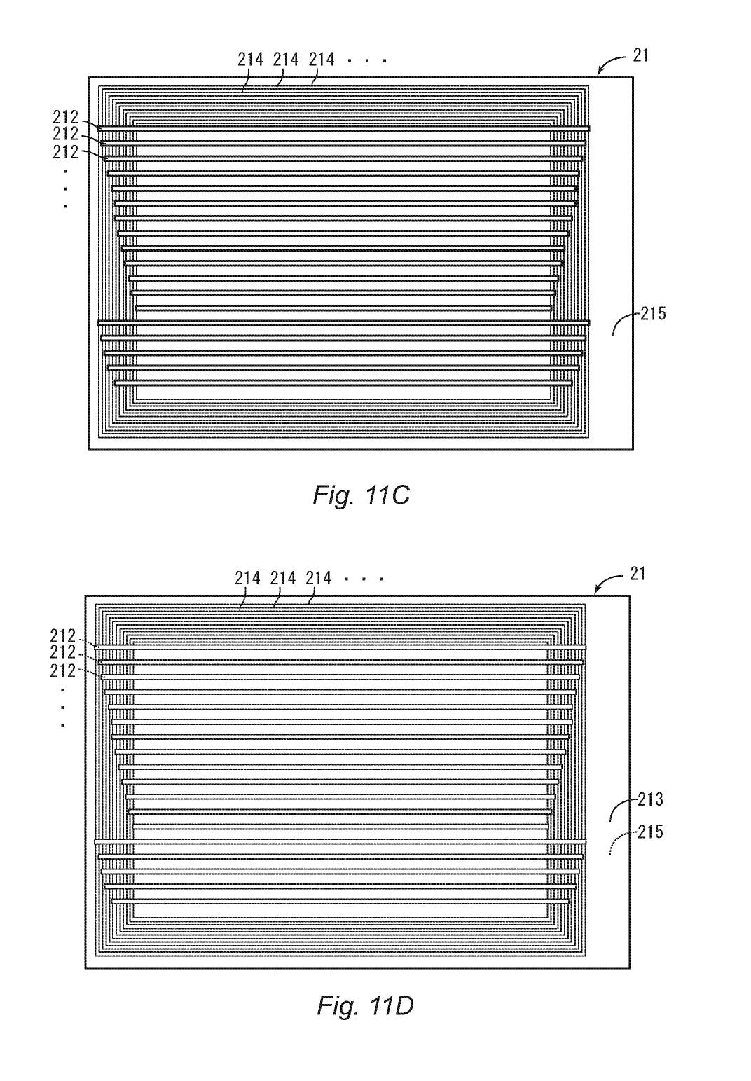

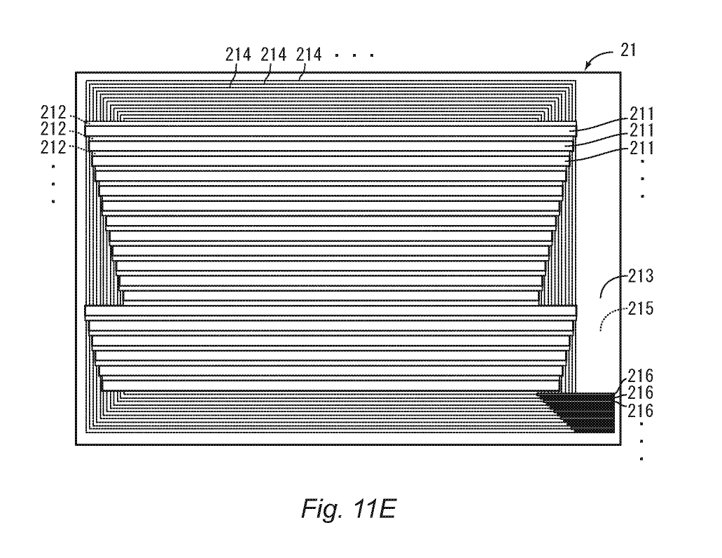

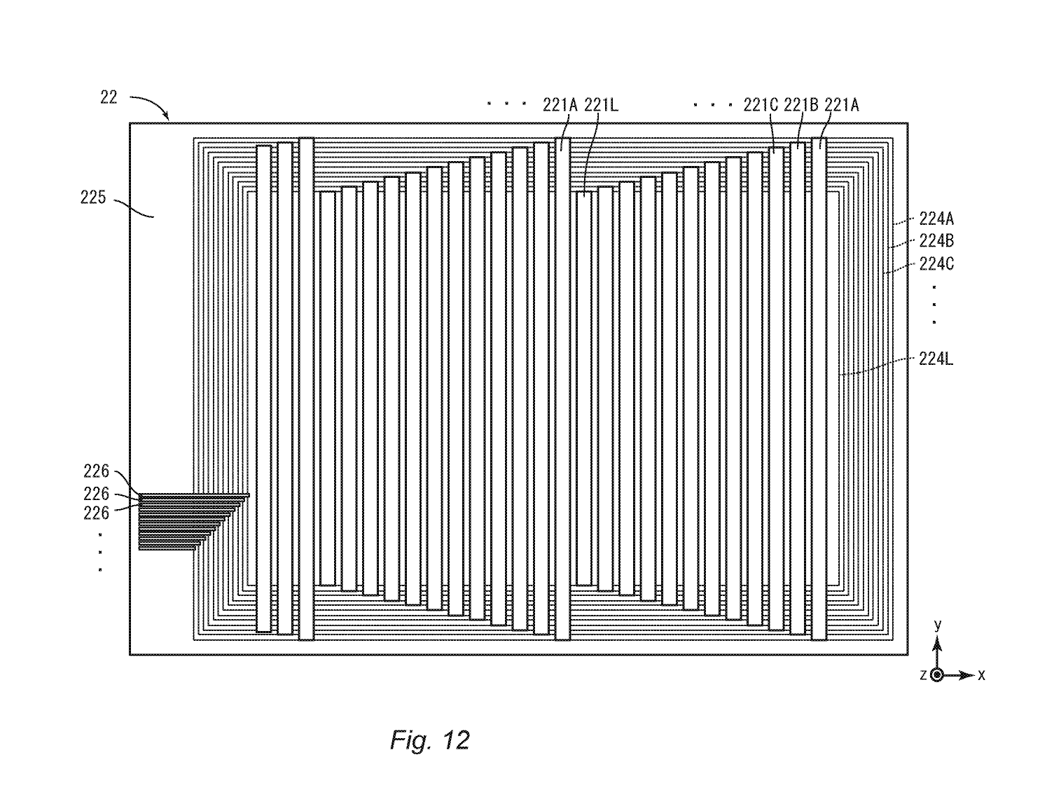

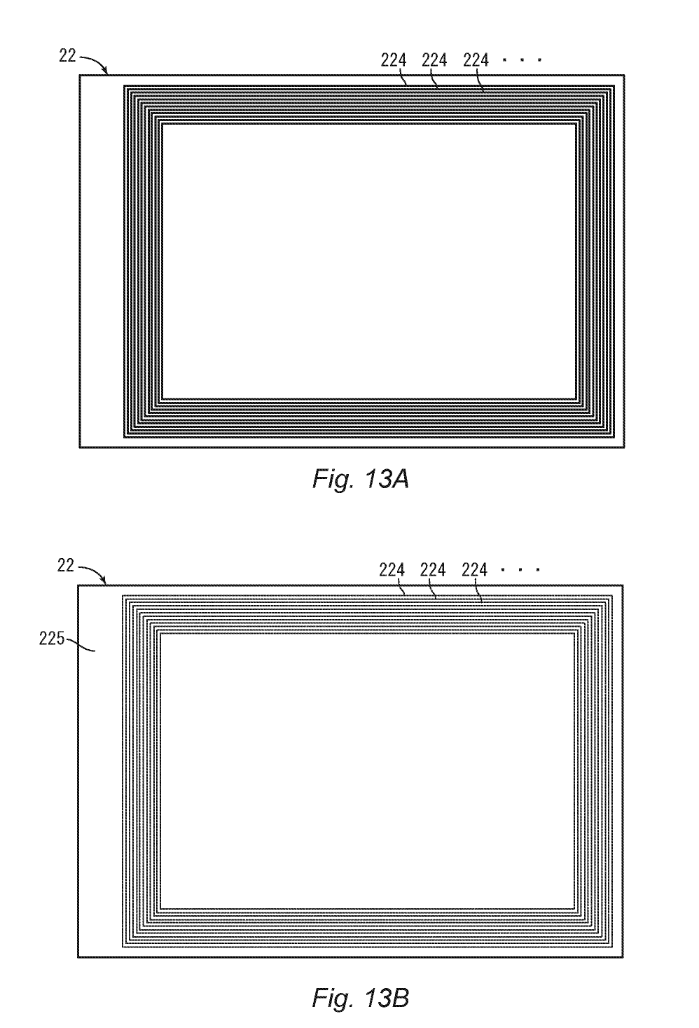

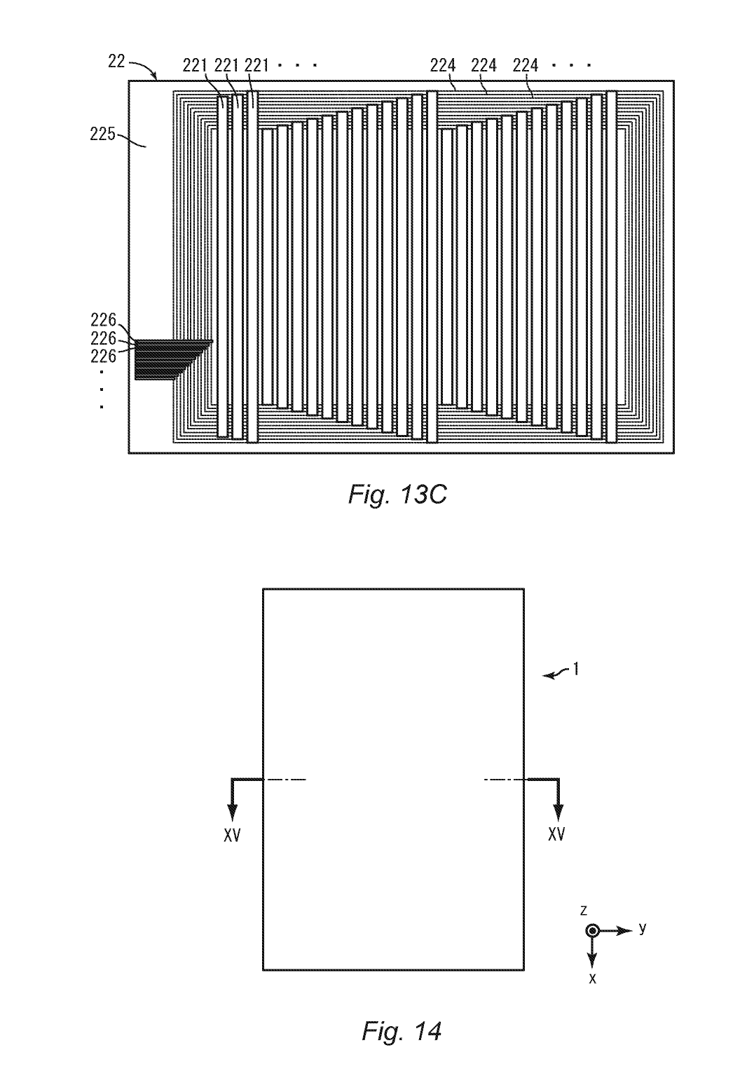

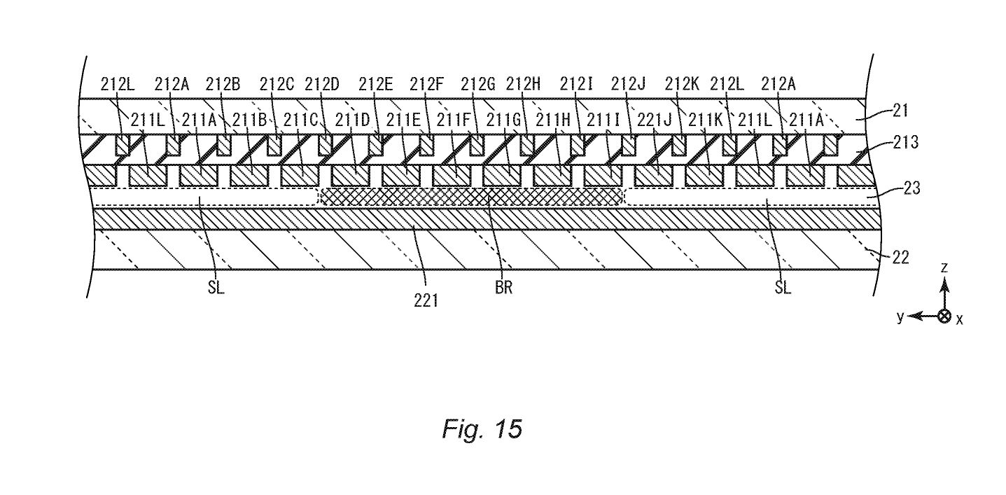

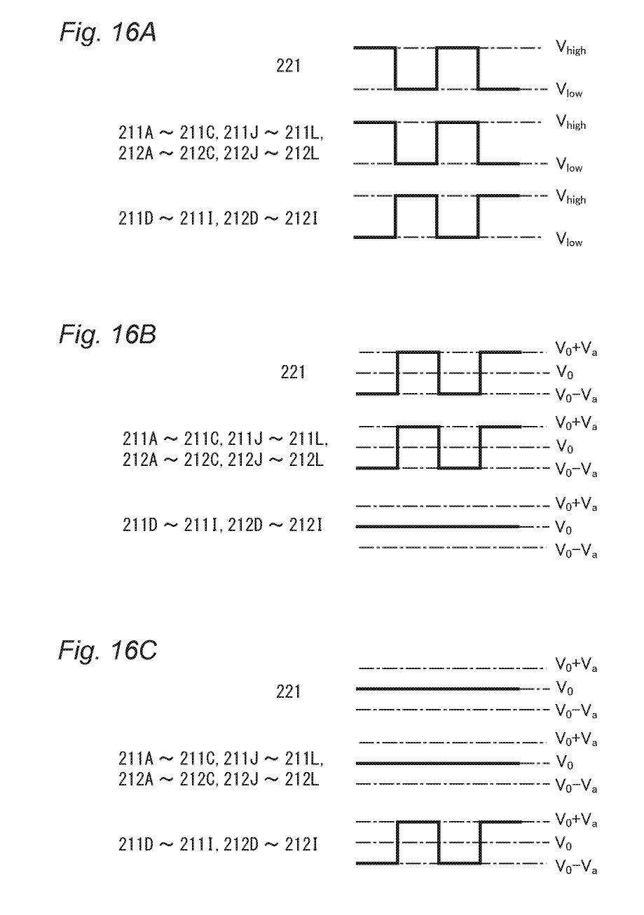

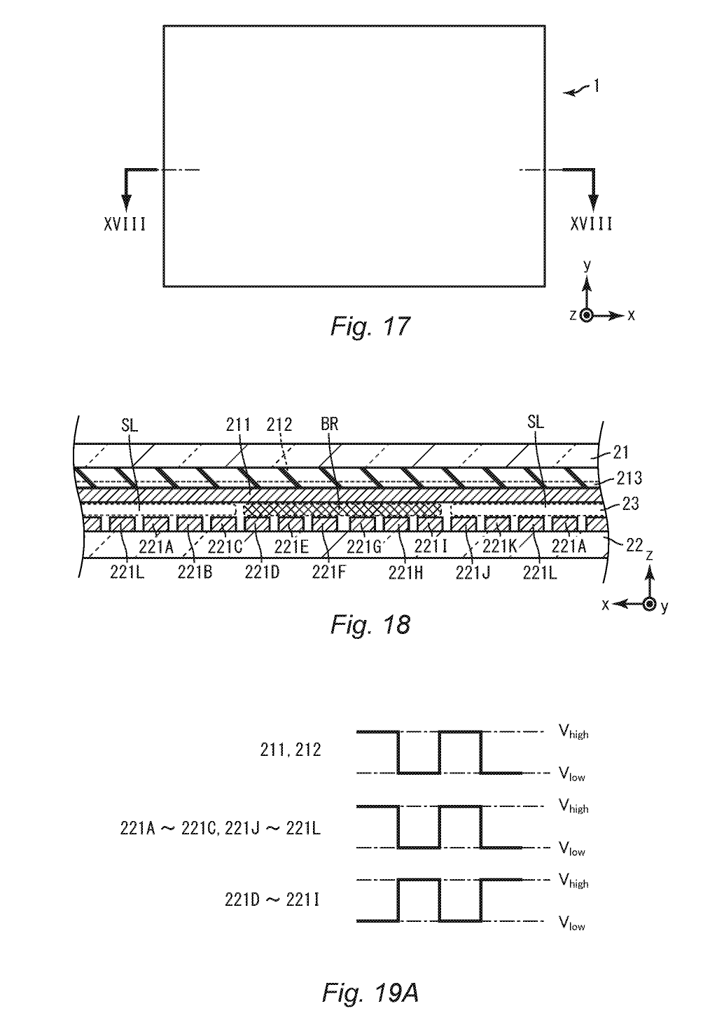

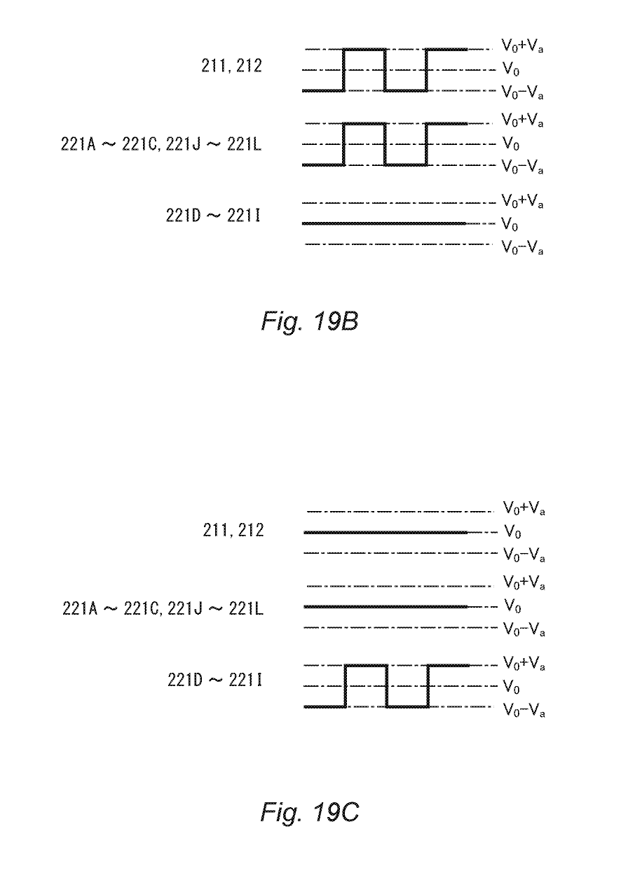

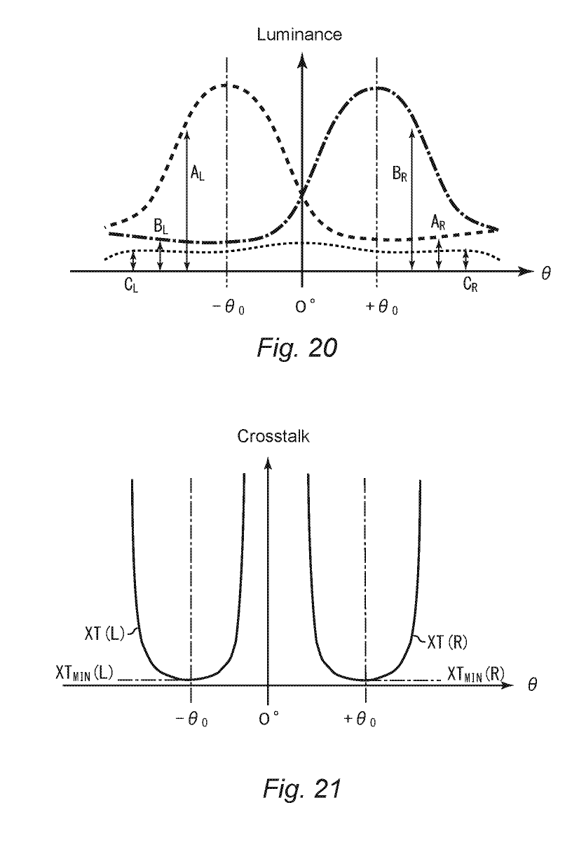

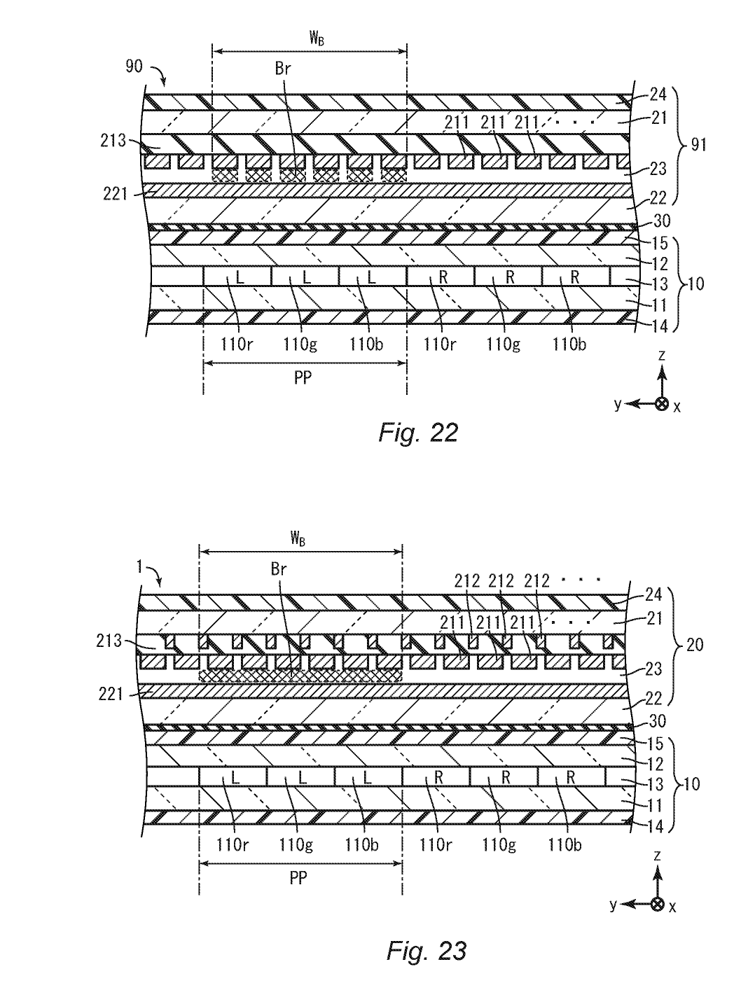

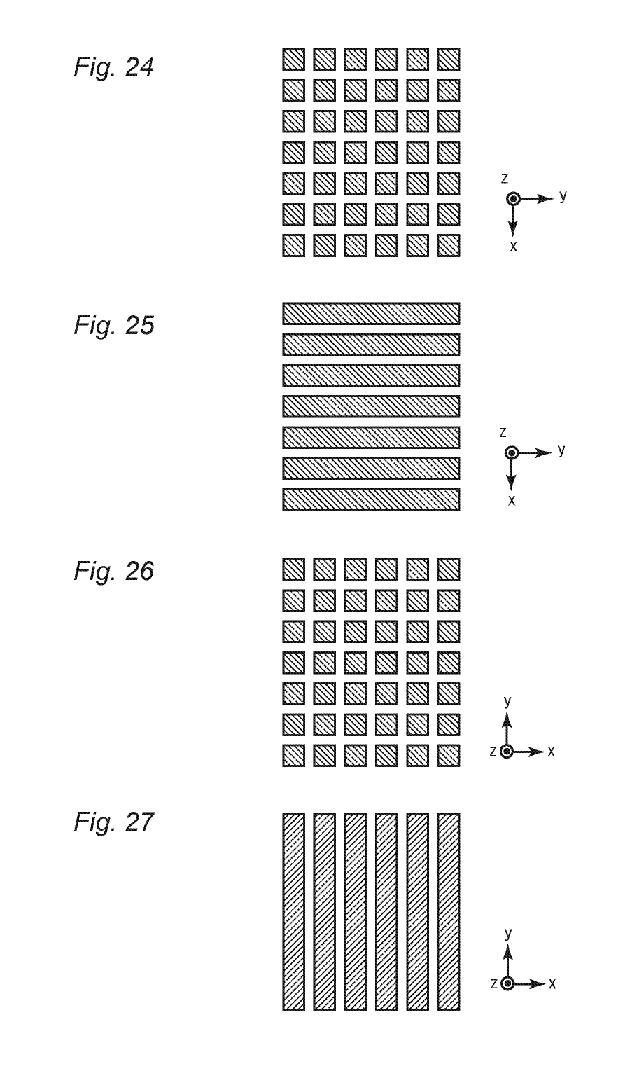

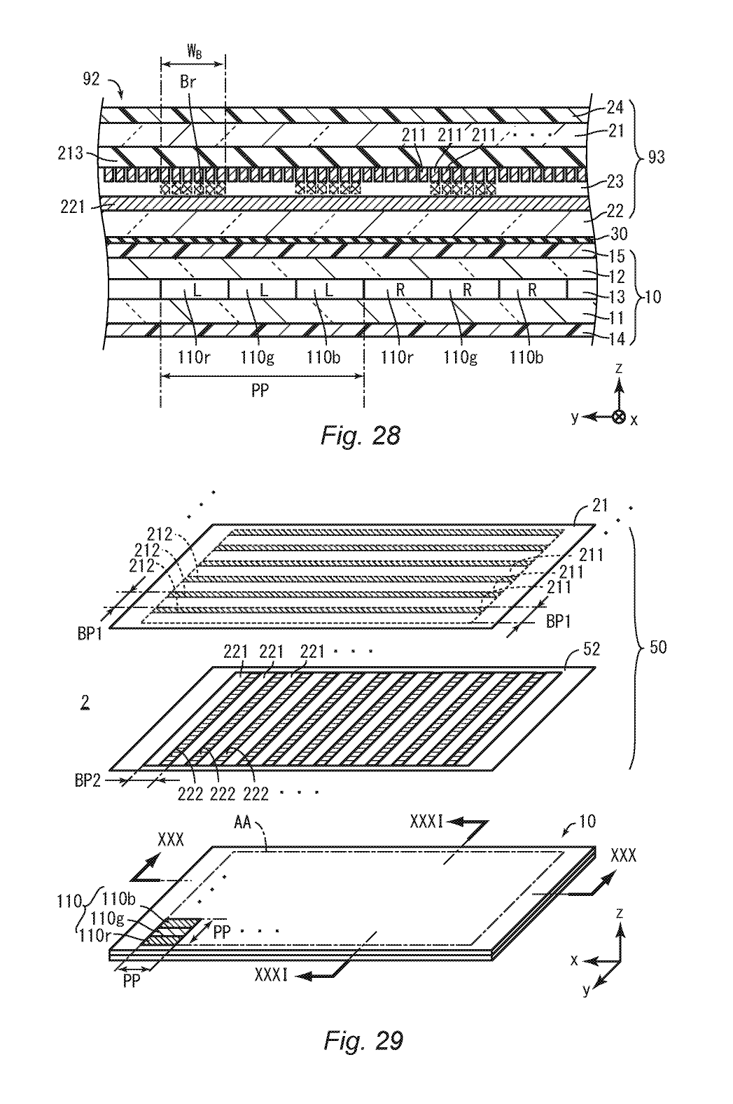

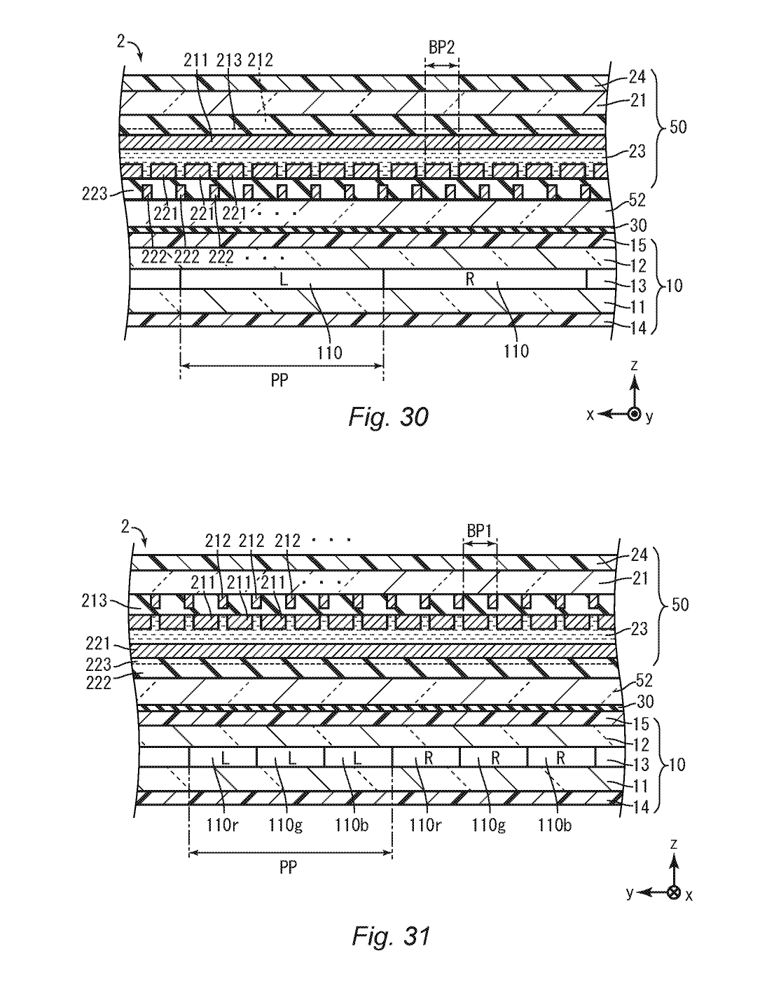

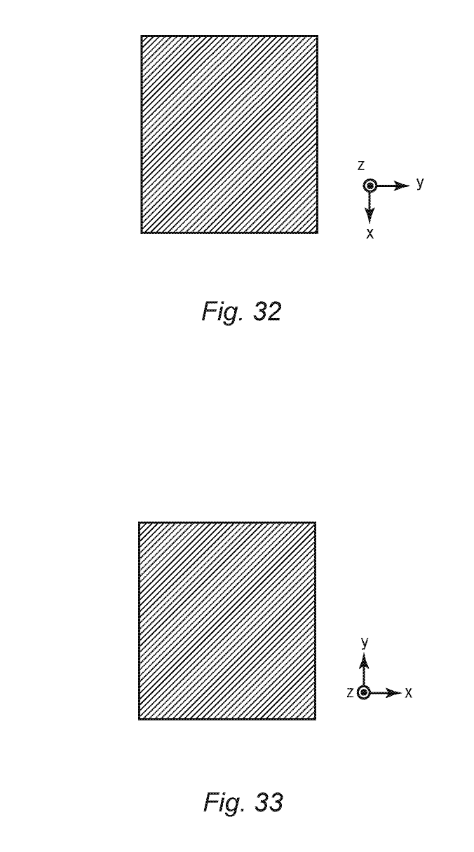

### BRIEF DESCRIPTION OF DRAWINGS

[FIG. 1] FIG. 1 is a cross-sectional view schematically illustrating a configuration of a stereoscopic display device according to Embodiment 1 of the present invention.

[FIG. 2] FIG. 2 is a block diagram illustrating a functional configuration of the stereoscopic display device according to Embodiment 1 of the present invention.

[FIG. 3] FIG. 3 is a flowchart of a processing operation by the stereoscopic display device according to Embodiment 1 of the present invention.

[FIG. 4A] FIG. 4A is a view for explaining stereoscopic display in a case where a parallax barrier is fixed.

[FIG. 4B] FIG. 4B is a view for explaining stereoscopic display in a case where the parallax barrier is fixed.

[FIG. 4C] FIG. 4C is a view for explaining stereoscopic display in a case where the parallax barrier is fixed.

[FIG. 5A] FIG. 5A is a view for explaining principles of the stereoscopic display by the stereoscopic display device according to Embodiment 1.

[FIG. 5B] FIG. 5B is a view for explaining principles of the stereoscopic display by the stereoscopic display device according to Embodiment 1.

[FIG. 5C] FIG. 5C is a view for explaining principles of the stereoscopic display by the stereoscopic display device according to Embodiment 1.

[FIG. 6] FIG. 6 is an exploded perspective view schematically illustrating a configuration of the stereoscopic display device according to Embodiment 1 of the present invention.

[FIG. 7] FIG. 7 is a cross-sectional view taken along line VII-VII in FIG. 6.

[FIG. 8] FIG. 8 is a cross-sectional view taken along line VIII-VIII in FIG. 6.

[FIG. 9] FIG. 9 illustrates an enlarged view of a part in FIG. 8.

[FIG. 10] FIG. 10 is a plan view of a first substrate of a switching liquid crystal panel when it is viewed from a second substrate side.

[FIG. 11A] FIG. 11A is a view for explaining an exemplary method for producing the first substrate.

[FIG. 11B] FIG. 11B is a view for explaining the exemplary method for producing the first substrate.

[FIG. 11C] FIG. 11C is a view for explaining the exemplary method for producing the first substrate.

[FIG. 11D] FIG. 11D is a view for explaining the exemplary method for producing the first substrate.

[FIG. 11E] FIG. 11E is a view for explaining the exemplary method for producing the first substrate.

[FIG. 12] FIG. 12 is a plan view of a second substrate of the switching liquid crystal panel when it is viewed from a first substrate side.

[FIG. 13A] FIG. 13A is a view for explaining an exemplary method for producing the second substrate.

[FIG. 13B] FIG. 13B is a view for explaining the exemplary method for producing the second substrate.

[FIG. 13C] FIG. 13C is a view for explaining the exemplary method for producing the second substrate.

[FIG. 14] FIG. 14 is a plan view illustrating a state where the y direction of the stereoscopic display device is parallel with the horizontal direction.

[FIG. 15] FIG. 15 is a cross-sectional view taken along line XV-XV in FIG. 14, the cross-sectional view schematically illustrating one of barrier lighting states to be displayed on the switching liquid crystal panel.

[FIG. 16A] FIG. 16A is an exemplary waveform diagram of a signal that is supplied to electrodes so as to cause the switching liquid crystal panel to have the barrier lighting state illustrated in FIG. 15.

[FIG. 16B] FIG. 16B is another exemplary waveform diagram of a signal that is supplied to electrodes so as to cause the switching liquid crystal panel to have the barrier lighting state illustrated in FIG. 15.

[FIG. 16C] FIG. 16C is still another exemplary waveform diagram of a signal that is supplied to electrodes so as to cause the switching liquid crystal panel to have the barrier lighting state illustrated in FIG. 15.

[FIG. 17] FIG. 17 is a plan view illustrating a state where the x direction of the stereoscopic display device is parallel with the horizontal direction.

[FIG. 18] FIG. 18 is a cross-sectional view taken along line XVIII-XVIII in FIG. 17, the cross-sectional view schematically illustrating one of barrier lighting states to be displayed on the switching liquid crystal panel.

[FIG. 19A] FIG. 19A is an exemplary waveform diagram of a signal that is supplied to electrodes so as to cause the switching liquid crystal panel to have the barrier lighting state illustrated in FIG. 18.

[FIG. 19B] FIG. 19B is another exemplary waveform diagram of a signal that is supplied to electrodes so as to cause the switching liquid crystal panel to have the barrier lighting state illustrated in FIG. 18.

[FIG. 19C] FIG. 19C is still another exemplary waveform diagram of a signal that is supplied to electrodes so as to cause the switching liquid crystal panel to have the barrier lighting state illustrated in FIG. 19.

[FIG. 20] FIG. 20 illustrates angle characteristics of the luminance of the stereoscopic display device when the barrier lighting state is fixed.

[FIG. 21] FIG. 21 illustrates angle characteristics of crosstalk XT(L) for the left eye and crosstalk XT(R) for the right eye.

[FIG. 22] FIG. 22 is a schematic cross-sectional view illustrating a configuration of a stereoscopic display device according to a virtual comparative example.

[FIG. 23] FIG. 23 is a schematic cross-sectional view illustrating a configuration of the stereoscopic display device according to Embodiment 1 of the present invention.

[FIG. 24] FIG. 24 schematically illustrates a state of barriers in the portrait 3D mode in the stereoscopic display device according to the comparative example.

[FIG. 25] FIG. 25 schematically illustrates a state of barriers in the portrait 3D mode in the stereoscopic display device according to Embodiment 1 of the present invention.

[FIG. 26] FIG. 26 schematically illustrates a state of barriers in the landscape 3D mode in the stereoscopic display device according to the comparative example.

[FIG. 27] FIG. 27 schematically illustrates a state of barriers in the landscape 3D mode in the stereoscopic display device according to Embodiment 1 of the present invention.

[FIG. 28] FIG. 28 is a schematic cross-sectional view illustrating a configuration of a stereoscopic display device according to another comparative example.

[FIG. 29] FIG. 29 is an exploded perspective view schematically illustrating a configuration of a stereoscopic display device according to Embodiment 2 of the present invention.

[FIG. 30] FIG. 30 is a cross-sectional view taken along line XXX-XXX in FIG. 29.

[FIG. 31] FIG. 31 is a cross-sectional view taken along line XXXI-XXXI in FIG. 29.

[FIG. 32] FIG. 32 schematically illustrates a state of barriers in the portrait 3D mode in the stereoscopic display device according to Embodiment 2 of the present invention.

[FIG. 33] FIG. 33 schematically illustrates a state of barriers in the landscape 3D mode in the stereoscopic display device according to Embodiment 2 of the present invention.

### MODE FOR CARRYING OUT THE INVENTION

A stereoscopic display device according to one embodiment of the present invention includes a display panel; a switching liquid crystal panel that is arranged so as to be stacked on the display panel; a position sensor that acquires position information of a viewer; and a control device that controls the switching liquid crystal panel. The switching liquid crystal panel includes: a first substrate and a second substrate that are arranged so as to be opposed to each other; a liquid crystal layer interposed between the first substrate and the second substrate; a plurality of first electrodes formed on the first substrate, arranged along a first direction at first intervals; a plurality of auxiliary electrodes formed on the first substrate, arranged along the first direction at the first intervals; an insulating film that insulates the first electrodes and the auxiliary electrodes from each other; and a plurality of second electrodes formed on the second substrate, arranged along a second direction that intersects with the first direction at second intervals. The auxiliary electrodes are arranged between the first electrodes, when viewed in a plan view. The control device includes a driving circuit that controls potentials of the first electrodes, the second electrodes, and the auxiliary electrodes, based on the position information (the first configuration).

According to the above-described configuration, the stereoscopic display device includes a display panel, a switching liquid crystal panel, a position sensor, and a control device. The position sensor acquires position information of a viewer. The control device controls the switching liquid crystal panel based on the position information. With this configuration, the ON state of the switching liquid crystal panel can be changed according to the position of a viewer. This enables to widen the viewing range during 3D display.

The switching liquid crystal panel includes the first substrate, the second substrate, and the liquid crystal layer. On the first substrate, a plurality of first electrodes are formed along the first direction, and on the second substrate, a plurality of second electrodes are formed along the second direction. The control device forms electric fields in the liquid crystal layer, by controlling the potentials of the first electrodes and the second electrodes, whereby barriers can be formed along the first direction or the second direction. This allows stereoscopic display to be performed in a plurality of orientations.

On the first substrate, there are further provided a plurality of auxiliary electrodes arrayed along the first direction. The auxiliary electrodes are formed at the first intervals, which are the same as the intervals for the first electrodes. The auxiliary electrodes are arranged between the first electrodes when viewed in a plan view. The auxiliary electrodes and the first electrodes are insulated from each other by the insulating film. With this configuration, electric fields can be formed in areas between adjacent ones of the first electrodes (inter-line areas), by the auxiliary electrodes. This enables to reduce light leakage in the inter-line areas, thereby decreasing crosstalk.

In the first configuration described above, preferably, the display panel includes a plurality of pixels arranged in matrix; the control device causes the switching liquid crystal panel to display a parallax barrier in which transmitting regions and non-transmitting regions are formed in periodic fashion, in accordance with the position information; and each width of the non-transmitting regions is equal to each interval of the pixels (the second configuration).

According to the above-described configuration, even if the non-transmitting regions move according to a viewer's position, light is blocked in portions having the same width as the width of the pixel intervals. This makes it possible to reduce luminance variation when the non-transmitting regions move, irrespective of the aperture ratio of the pixels. Further, with this configuration, since the electric fields of the inter-line areas of the first electrodes can be controlled by the auxiliary electrodes, the width of the non-transmitting regions can be controlled in the first direction more precisely.

In the second configuration described above, preferably, each of the pixels includes a plurality of subpixels that display colors different from one another, respectively, and the subpixels are arranged along the first direction (the third configuration).

According to the above-described configuration, the alignment direction in which the subpixels are aligned is the first direction. As described above, the width of the non-transmitting regions can be controlled in the first direction more precisely by the auxiliary electrodes. It is therefore possible to prevent such a problem that lights from the subpixels displaying different colors are observed as being mixed due to light leakage.

In any one of the first to third configurations, preferably, each width of the first electrodes is greater than each width of the auxiliary electrodes (the fourth configuration).

The first electrodes and the auxiliary electrodes have a greater electric resistance as the width thereof is smaller. In a case where the width of the first electrodes and the width of the auxiliary electrodes are set to be equal to each other, the width of the electrodes is too small, which possibly causes crosstalk to increase. It is therefore preferable that the width of the first electrodes is set to be greater than the width of the auxiliary electrodes, and the light shielding properties of the barriers are ensured with use of the first electrodes, while supplementary light shielding properties are provided by the auxiliary electrodes.

In any one of the first to fourth configurations, preferably, the first electrodes and the auxiliary electrodes are arranged so as not to overlap when viewed in a plan view (the fifth configuration).

With the above-described configuration, the electric fields applied to the liquid crystal layer can be made more uniform.

In any one of the first to fifth configurations, preferably, the first electrodes are arranged on the second substrate side with respect to the auxiliary electrodes (the sixth configuration).

According to the above-described configuration, the first electrodes are arranged on the liquid crystal layer side with respect to the insulating film. This makes the influence of the insulating film onto the first electrodes smaller, and the light shielding properties can be increased in some cases.

In any one of the first to sixth configurations, preferably, the switching liquid crystal panel further includes: a plurality of second auxiliary electrodes formed on the second substrate, arranged along the second direction at the second intervals; and a second insulating film that insulates the second electrodes and the second auxiliary electrodes from each other. The second auxiliary electrodes are preferably arranged between the second electrodes, when viewed in a plan view (the seventh configuration).

According to the above-described configuration, electric fields can be formed between adjacent ones of the second electrodes by the second auxiliary electrodes. It is therefore possible to reduce light leakage in the inter-line areas in the second direction as well.

In any one of the first to seventh configurations, preferably, the display panel is a liquid crystal display panel (the eighth configuration).

### EMBODIMENT

The following describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

### EMBODIMENT 1

### Overall Configuration

FIG. 1 is a schematic cross-sectional view illustrating a configuration of a stereoscopic display device 1 according to Embodiment 1 of the present invention. The stereoscopic display device 1 includes a display panel 10, a switching liquid crystal panel 20, and an adhesive resin 30. The display panel 10 and the switching liquid crystal panel 20 are arranged so as to be stacked in such a manner that the switching liquid crystal panel 20 is positioned on the viewer 90 side, and are bonded with each other with the adhesive resin 30.

The display panel 10 includes a thin film transistor (TFT) substrate 11, a color filter (CF) substrate 12, a liquid crystal layer 13, and polarizing plates 14, 15. The display panel 10 controls TFT substrate 11 and the CF substrate 12 so as to operate the alignment of liquid crystal molecules in the liquid crystal layer 13, thereby to display images.

The switching liquid crystal panel 20 includes a first substrate 21, a second substrate 22, a liquid crystal layer 23, and a polarizing plate 24. The first substrate 21 and the second substrate 22 are arranged so as to be opposed to each other. The liquid crystal layer 23 is interposed between the first substrate 21 and the second substrate 22. The polarizing plate 24 is arranged on the viewer 90 side.

Though FIG. 1 does not illustrate detailed configurations, electrodes are formed on the first substrate 21 and the second substrate 22. The switching liquid crystal panel 20 controls potentials of these electrodes so as to operate the alignment of liquid crystal molecules of the liquid crystal layer 23, thereby to change behavior of light passing through the liquid crystal layer 23. More specifically, the switching liquid crystal panel 20 forms non-transmitting regions (barriers) that block light, and transmitting regions (slits) that transmit light, by using the alignment of the liquid crystal molecules of the liquid crystal layer 23 and the operations of the polarizing plate 15 and the polarizing plate 24. The configurations and operations of the first substrate 21 and the second substrate 22 are to be described in detail below.

The polarizing plate 15 and the polarizing plate 24 are arranged in such a manner that light transmission axes thereof intersect at right angles. The switching liquid crystal panel 20 is a so-called normally white liquid crystal, which has the greatest transmittance when no voltage is applied to the liquid crystal layer 23. Since the normally white liquid crystal is in a no voltage applied state in the two-dimensional display mode, the electric power consumption during 2D display can be reduced.

The polarizing plate 15 may be arranged on the switching liquid crystal panel 20. More specifically, the configuration may be such that the polarizing plate 15 is arranged on a surface on the display panel 10 side of the second substrate 22 of the switching liquid crystal panel 20, and the adhesive resin 30 is arranged between the polarizing plate 15 and the CF substrate 12.

Hereinafter, the thickness direction of the stereoscopic display device 1 is referred to as the “z direction”, one of the directions along the outer shape of the stereoscopic display device 1 is referred to as the “x direction”, and the direction vertical to these is referred to as the “y direction”. Further, the direction parallel to the line segment extending between the left eye 90L and the right eye 90R of the viewer 90 (the x direction in the case of FIG. 1) is referred to as “horizontal direction”, and the direction intersecting at right angle with the horizontal direction in the plane of the display panel 10 (the y direction in the case of FIG. 2) is referred to as “vertical direction”.

FIG. 2 is a block diagram illustrating a functional configuration of the stereoscopic display device 1. FIG. 3 is a flowchart of a processing operation by the stereoscopic display device 1. The stereoscopic display device 1 further includes a control device 40, a position sensor 41, and an inertia sensor 45. The control device 40 includes an arithmetic circuit 42, a switching liquid crystal panel driving circuit (driving circuit) 43, and a display panel driving circuit 44.

The display panel driving circuit 44 drives the display panel 10 based on video signals supplied from outside, so as to causes the display panel 10 to display images.

The inertia sensor 45 measures the posture of the stereoscopic display device 1. The inertia sensor 45 is, for example, an acceleration sensor, or a gyro sensor. The inertia sensor 45 supplies the acquired information of the posture to the arithmetic circuit 42 of the control device 40.

The arithmetic circuit 42 switches the driving mode of the switching liquid crystal panel 20 based on the posture of the stereoscopic display device 1. More specifically, the arithmetic circuit 42 switches the driving mode between a driving mode in which the x direction of the stereoscopic display device 1 is assumed to be the horizontal direction (hereinafter, this mode is referred to as “landscape 3D mode”), and a driving mode in which the y direction is assumed to be the horizontal direction (hereinafter, this mode is referred to as “portrait 3D mode).

The position sensor 41 acquires position information of the viewer 90 (Step S1). The position sensor 41 is, for example, a camera or an infrared light sensor. The position sensor 41 supplies the acquired position information to the arithmetic circuit 42 of the control unit 40.

The arithmetic circuit 42 analyzes the position information of the viewer 90 supplied from the position sensor 41, and calculates position coordinates (x, y, z) of the viewer 90 (Step S2). The calculation of the position coordinates can be performed by, for example, an eye tracking system for detecting the positions of the eyes of the viewer 90 by image processing. Alternatively, the calculation of the position coordinates may be performed by a head tracking system for detecting the position of the head of the viewer 90 with infrared light.

The arithmetic circuit 42 further determines a barrier lighting state of the switching liquid crystal panel 20 according to the position coordinates of the viewer 90 and the driving mode (Step S3). More specifically, according to the position coordinates of the viewer 90 and the driving mode, the positions of the barriers and the positions of the slits of the switching liquid crystal panel 20 are determined. The arithmetic circuit 42 supplies the determined information of the barrier lighting state to the switching liquid crystal panel drive unit 43.

The switching liquid crystal panel drive unit 43 drives the switching liquid crystal panel 20 based on the information supplied from the arithmetic circuit 42 (Step S4). Thereafter, Steps S1 to S4 are repeated.

In the present embodiment, the display mode is automatically switched according to the posture of the stereoscopic display device 1 by using the inertia sensor 45. The configuration of the stereoscopic display device 1, however, may be such that the display mode is switched manually.

Next, the following description explains principles of the stereoscopic display by the stereoscopic display device 1, using FIGS. 4A to 4C and FIGS. 5A to 5C.

First of all, a case is explained where the barrier lighting state is fixed, with reference to FIGS. 4A to 4C. The display panel 10 includes a plurality of pixels 110. On the pixels 110, a right-eye image (R) and a left-eye image (L) are displayed alternately in the horizontal direction. In the switching liquid crystal panel 20, barriers BR that block light and slits SL that transmit light are formed at predetermined intervals. This allows only the right-eye image (R) to be visible to the right eye 90R of the viewer 90, and allows only the left-eye image (L) to be visible to the left eye 90L, as illustrated in FIG. 4A. This allows the viewer 90 to have a stereoscopic vision.

The interval PP of the pixels 110 and the interval φ of the barriers BR satisfy the following expression when S2 is sufficiently greater than S1:

φ≈2×PP

where S1 is a distance from the display surface of the display panel 10 to the barriers BR, and S2 is a distance from the barriers BR to the viewer 90.

FIG. 4B illustrates a state in which the viewer 90 has moved from the position shown in FIG. 4A in the horizontal direction. In this case, to the right eye 90R of the viewer 90, both of the right-eye image (R) and the left-eye image (L) are visible. Similarly, to the left eye 90L, both of the right-eye image (R) and the left-eye image (L) are visible. In other words, crosstalk is occurring, and the viewer 90 cannot have a stereoscopic vision.

FIG. 4C illustrates a state in which the viewer 90 has further moved from the position shown in FIG. 4B in the horizontal direction. In this case, to the right eye 90R of the viewer 90, the left-eye image (L) is visible, and to the left eye 90L thereof, the right-eye image (R) is visible. In this case, the state of pseudoscopic vision occurs wherein a video image that should be recognized as being positioned behind is observed in the foreground, and in contrast, a video image that should be recognized as being positioned in the foreground is observed behind, which makes the viewer 90 unable to have an appropriate stereoscopic vision, and gives uncomfortable feeling to him/her.

In this way, as the viewer 90 moves, a normal area where a stereoscopic vision can be obtained, a crosstalk area where crosstalk occurs, and a pseudoscopic area where the state of pseudoscopic vision occurs, appear repeatedly. Therefore, in the case where the barrier lighting state is fixed, the viewer 90 can have a stereoscopic vision only in limited areas.

In the present embodiment, the control unit 40 changes the barrier lighting state of the switching liquid crystal panel 20 according to the position information (position coordinates) of the viewer 90, as illustrated in FIGS. 5A to 5C. This allows the viewer 90 to have a stereoscopic vision always, and prevents crosstalk and the state of pseudoscopic vision from occurring.

The following description describes the configuration of the display device 1 in detail, while referring to FIGS. 6 to 8. FIG. 6 is an exploded perspective view schematically illustrating a configuration of the stereoscopic display device 1. Incidentally, in FIG. 6, the illustration of the liquid crystal layer 23, the polarizing plates 14, 15, 24, and the like is omitted. FIG. 7 is a cross-sectional view taken along line VII-VII in FIG. 6. FIG. 8 is a cross-sectional view taken along line VIII-VIII in FIG. 6.

As described above, the display panel 10 includes a plurality of pixels 110. The pixels 110 are arranged in matrix in an active area AA of the display panel 10. The pixels 110 are arrayed at intervals PP in both of the x direction and the y direction. In other words, the display panel 10 is configured so that the aspect ratio of the pixel 110 is 1:1.

Each of the pixels 110 includes subpixels 110r, 110g, and 110b. The subpixel 110r displays red color, the subpixel 110g displays green color, and the subpixel 110b displays blue color. The subpixels 110r, 110g, 110b are arranged along the y direction, thereby trisecting the pixel 110 equally in the y direction. In other words, the subpixels 110r, 110g, 110b are arrayed in the y direction at intervals of PP/3.

On the first substrate 21 of the switching liquid crystal panel 20, on a surface thereof opposed to the second substrate 22, a plurality of first electrodes 211 and a plurality of auxiliary electrodes 212 are formed. In FIG. 6, the auxiliary electrodes 212 are hatched, to make the diagram clearer.

The first electrodes 211 are arranged along the y direction (first direction) at intervals BP1 (first intervals). Each of the first electrodes 211 is formed so as to extend in the x direction. The auxiliary electrodes 212 arranged along the y direction at intervals BP1, as is the case with the first electrodes 211. Each of the auxiliary electrodes 212 is also formed so as to extend in the x direction. The auxiliary electrodes 212 are arranged between the first electrodes 211 when viewed in a plan view. Between the first electrodes 211 and the auxiliary electrodes 212, an insulating film 212 (FIG. 8) is arranged, so that these electrodes are not short-circuited.

On the second substrate 22 of the switching liquid crystal panel 20, on a surface thereof opposed to the first substrate 21, a plurality of second electrodes 221 are formed.

The second electrodes 221 are arranged along the x direction (second direction) at intervals BP2 (second intervals). Each of the second electrodes 221 is formed so as to extend in the y direction.

The display device 1 is configured so that BP1=BP2≈PP/6 is satisfied.

FIG. 9 illustrates an enlarged view of a part in FIG. 8. In the present embodiment, the first electrodes 211 and the auxiliary electrodes 212 are arranged so as not overlap each other when viewed in a plan view (viewed in the xy plane). The first electrodes 211 and the auxiliary electrodes 212 are formed so that “W” representing the width of each of the first electrodes 211 (the size along the y direction), and “Ws” representing the width of each of the auxiliary electrodes 212 (the size along the y direction) satisfy BP1=W+Ws. The width W of the first electrode 211 is greater than the width Ws of the auxiliary electrode 212.

The display device 1 can be configured so that, for example, the following are satisfied:

PP=80.7 μm,

BP1=BP2=13.45 μm≈PP/6,

W=9.45 μm,

and

Ws=4 μm.

### Configuration of Switching Liquid Crystal Panel 20

The following description describes more specific configurations of the switching liquid crystal panel 20, and an exemplary method for producing the same, while referring to FIGS. 10, 11A to 11E, 12, and 13A to 13C. The configuration of the switching liquid crystal panel 20 and the method for producing the same are not limited to these.

FIG. 10 is a plan view of a first substrate 21 of a switching liquid crystal panel 20 when it is viewed from a second substrate 22 side (the negative side in the z direction). On the first substrate 21, there are further provided a plurality of lines 214 (214A to 214L), an insulating film 215, and a plurality of terminals 216 in addition to the first electrodes 211 (211A to 211L), the auxiliary electrodes 212 (212A to 212L), and an insulating film 213.

The first substrate 21 is, for example, a glass substrate. The first electrodes 211, the auxiliary electrodes 212, and the terminals 216 are, for example, transparent conductive films of ITO or the like. The lines 214 are, for example, metal films of aluminum or the like. The insulating films 213, 215 are, for example, transparent insulating films of SiN or the like.

The lines 214, the insulating film 215, the auxiliary electrodes 212, the insulating film 213, and the first electrodes 211 are laminated in the stated order from the first substrate 21 side. The terminals 216 are formed in the same layer as the first electrodes 211.

The lines 214 are formed along the periphery of the first substrate 21, in a ring form. The lines 214 are arranged outside the active area AA (FIG. 6) of the display panel when viewed in a plan view.

The lines 214 are electrically connected to the terminals 216, respectively, through contact holes (not shown) that are formed to pass through the insulating films 213, 215. The lines 214, similarly, are electrically connected to the first electrodes 211, respectively, through contact holes (not shown) that are formed in the insulating films 213, 215, and are electrically connected to the auxiliary electrodes 212, respectively, through contact holes (not shown) that are formed in the insulating film 213. With this configuration, the terminals 216, and the first electrodes 211 as well as the auxiliary electrodes 212, are electrically connected with each other through the lines 214.

To the terminals 216, signals are supplied from the control device 40 (FIG. 2). In the present embodiment, 12 lines 214 (214A to 214L), and 12 terminals 216 are formed, and signals of 12 systems are supplied from the control device 40 (FIG. 2).

Here, in a case where it is necessary to individually distinguish the lines 214, the lines are referred to as lines 214A, 214B . . . 214L. Besides, the first electrode 211 connected to the line 214A is referred to as a first electrode 211A, the first electrode 211 connected to the line 214B is referred to as a first electrode 211B, . . . and the first electrode 211 connected to the line 214L is referred to as a first electrode 211L.

Similarly, the auxiliary electrode 212 connected to the line 214A is referred to as an auxiliary electrode 212A, the auxiliary electrode 212 connected to the line 214B is referred to as an auxiliary electrode 212B, . . . and the auxiliary electrode 212 connected to the line 214L is referred to as an auxiliary electrode 212L.

In the present embodiment, the first electrode 211A and the auxiliary electrode 212A are connected to the same line, the line 214A. To the first electrode 211A and the auxiliary electrode 212A, therefore, an identical signal is supplied. Similarly, an identical signal is supplied to the first electrode 211B and the auxiliary electrode 212B, . . . and an identical signal is supplied to the first electrode 211L and the auxiliary electrode 212L.

The first electrodes 211A, 211B, . . . and 211L are arranged along the y direction cyclically. More specifically, along the y direction, the first electrodes 211A, 211B, . . . 211L are arranged in the stated order so that the first electrode 211A is repeatedly adjacent to the first electrode 211L.

The auxiliary electrodes 212A, 212B, . . . 212L are similarly arranged along the y direction cyclically. The auxiliary electrode 212A is adjacent to the first electrode 211A when viewed in a plan view. Similarly, the auxiliary electrode 212B is adjacent to the first electrode 211B, . . . and the auxiliary electrode 212L is adjacent to the first electrode 211L, when viewed in a plan view.

The following description describes an exemplary method for producing the first substrate 21, while referring to FIGS. 11A to 11E.

First, as illustrated in FIG. 11A, the lines 214 are formed on the first substrate 21. The lines 214 are formed by, for example, forming a film by sputtering, and then, patterning the film by photolithography.

Next, as illustrated in FIG. 11B, the insulating film 215 is formed so as to cover the lines 214. The insulating film 215 is formed by, for example, chemical vapor deposition (CVD). In the insulating film 215, contact holes are formed at predetermined positions by, for example, photolithography.

Next, as illustrated in FIG. 11C, the auxiliary electrodes 212 are formed. The auxiliary electrodes 212 are formed by, for example, forming a film by sputtering or CVD, and then, patterning the film by photolithography.

Next, as illustrated in FIG. 11D, the insulating film 213 is form so as to cover the auxiliary electrodes 212. The insulating film 213 is formed by, for example, CVD. In the insulating film 213, contact holes are formed at predetermined positions, by, for example photolithography.

Next, as illustrated in FIG. 11E, the first electrodes 211 and the terminals 216 are formed. In the present embodiment, the first electrodes 211 and the terminals 216 are formed with the same material. The first electrodes 211 and the terminals 216 are formed by, for example, forming a film by sputtering or CVD, and then, patterning the film by photolithography. In this way, the first electrodes 211 and the terminals 216 are formed through the simultaneous film formation and patterning, whereby the number of steps can be decreased. The first electrodes 211 and the terminals 216, however, may be formed individually, with different materials.

FIG. 12 is a plan view of a second substrate 22 of the switching liquid crystal panel 20 when it is viewed from a first substrate 21 side (the positive side in the z direction). On the second substrate 22, there are provided a plurality of lines 224 (224A to 224L), an insulating film 225, and a plurality of terminals 226, in addition to the second electrodes 221(221A to 221L).

The second substrate 22 is, for example, a glass substrate. The second electrodes 221 and the terminals 226 are, for example, transparent conductive films of ITO or the like. The lines 224 are, for example, metal films of aluminum or the like. The insulating film 225 is, for example, a transparent insulating film of SiN or the like.

The lines 224, the insulating film 225, and the second electrodes 221 are laminated in the stated order from the second substrate 22 side. The terminals 226 are formed in the same layer as the second electrodes 221.

The lines 224 are formed along the periphery of the second substrate 22, in a ring form. The lines 224 are arranged outside the active area AA (FIG. 6) of the display panel when viewed in a plan view.

The lines 224 are electrically connected to the terminals 226, respectively, through contact holes (not shown) that are formed in the insulating film 225. Likewise, the lines 224 are electrically connected to the second electrodes 221 through contact holes (not shown) that are formed in the insulating film 225. With this configuration, the terminals 226 and the second electrodes 221 are electrically connected with each other via the lines 224.

To the terminals 226, signals are supplied from the control device 40 (FIG. 2). In the present embodiment, 12 lines 224 (224A to 224L), and 12 terminals 226 are formed, and signals of 12 systems are supplied from the control device 40 (FIG. 2).

Here, in a case where it is necessary to individually distinguish the lines 224, the lines are referred to as lines 224A, 224B . . . 224L. Besides, the second electrode 221 connected to the line 224A is referred to as a second electrode 221A, the second electrode 221 connected to the line 224B is referred to as a second electrode 221B, . . . and the second electrode 221 connected to the line 224L is referred to as a second electrode 221L.

The second electrodes 221A, 221B, . . . and 221L are arranged along the x direction cyclically. More specifically, along the x direction, the second electrodes 221A, 221B, . . . 221L are arranged in the stated order so that the second electrode 221A is repeatedly adjacent to the second electrode 221L.

The following description describes an exemplary method for producing the second substrate 22, while referring to FIGS. 13A to 13E.

First, as illustrated in FIG. 13A, the lines 224 are formed on the second substrate 22. The lines 224 are formed by, for example, forming a film by sputtering, and then, patterning the film by photolithography.

Next, as illustrated in FIG. 13B, the insulating film 225 is formed so as to cover the lines 224. The insulating film 225 is formed by, for example, CVD. In the insulating film 225, contact holes are formed at predetermined positions by, for example, photolithography.

Next, as illustrated in FIG. 13C, the second electrodes 221 and the terminals 226 are formed. In the present embodiment, the second electrodes 221 and the terminals 226 are formed with the same material. The second electrodes 221 and the terminals 226 are formed by, for example, forming a film by sputtering or CVD, and then, patterning the film by photolithography. The second electrodes 221 and the terminals 226, however, may be formed individually, with different materials.

### Method for Driving Switching Liquid Crystal Panel 20

The following description describes a method for driving the switching liquid crystal panel 20. The control device 40 (FIG. 2) of the stereoscopic display device 1 controls the driving mode for driving the switching liquid crystal panel 20, by switching the mode between the portrait 3D mode and the landscape 3D mode, as described above.

### Portrait 3D Mode

FIG. 14 is a plan view illustrating a state where the y direction of the stereoscopic display device 1 is parallel with the horizontal direction. Here, the control device 40 (FIG. 2) drives the switching liquid crystal panel 20 in the portrait 3D mode. In the portrait 3D mode, the barriers and the slits are formed along the y direction. FIG. 15 is a cross-sectional view taken along line XV-XV in FIG. 14, the cross-sectional view schematically illustrating one of barrier lighting states to be displayed on the switching liquid crystal panel 20. In FIG. 15, the illustration of the polarizing plate and the like is omitted.

In the portrait 3D mode, an identical signal is input to all of the second electrodes 221A to 221L (FIG. 12). Here, therefore, these are referred to as the second electrodes 221, without distinctions being made among these.

The control device 40 (FIG. 2) forms electric fields in the liquid crystal layer 23 by controlling the potentials of the first electrodes 211A to 211L, the auxiliary electrodes 212A to 212L, and the second electrodes 221, thereby forming the barriers BR and the slits SL. In the example illustrated in FIG. 15, the barriers BR are formed at positions that overlap the first electrodes 211D to 211I and the auxiliary electrodes 212D to 212I, and the slits SL are formed at positions that overlap the first electrodes 211A to 211C, 211J to 211L, and the auxiliary electrodes 212A to 212C, 212J to 212L.

FIG. 16A is an exemplary waveform diagram of a signal that is supplied to electrodes so as to cause the switching liquid crystal panel 20 to have the barrier lighting state illustrated in FIG. 15. In FIG. 16A, “221” indicates a waveform diagram of a signal supplied to the second electrodes 221. Similarly, “211A to 211C, 211J to 211L, 212A to 212C, 212J to 212L” indicates a waveform diagram of a signal supplied to the first electrodes 211A to 211C, 211J to 211L and the auxiliary electrodes 212A to 212C, 212J to 212L. “211D to 211I, 212D to 212I” indicates a waveform diagram of a signal supplied to the first electrodes 211D to 211I and the auxiliary electrodes 212D to 212I. The same applies to FIG. 16B and FIG. 16C to be described below.

In the example illustrated in FIG. 16A, all of the signals supplied to the first electrodes 211A to 211L, the auxiliary electrodes 212A to 212L, and the second electrodes 221 are rectangular waveforms taking two values of V_{high} and V_{low}. In this example, the signal supplied to the second electrodes 221, and the signal supplied to the first electrodes 211A to 211C, 211J to 211L and the auxiliary electrodes 212A to 212C, 212J to 212L have identical phases. On the other hand, the signal supplied to the second electrodes 221 and the signal supplied to the first electrodes 211D to 211I and the auxiliary electrodes 212D to 212I have phases opposite to each other.

This causes a potential difference of |V_{high}−V_{low}| to be formed between the second electrodes 221 and the first electrodes 211D to 211I, and between the second electrodes 221 and the auxiliary electrodes 211D to 221I. On the other hand, the potential difference between the second electrodes 221 and the first electrodes 211A to 211C, 211J to 211L, and the potential difference between the second electrodes 221 and the auxiliary electrodes 212A to 212C, 212J to 212L become approximately zero. As described above, the switching liquid crystal panel 20 is normally white liquid crystal. The barriers BR, therefore, are formed at portions having the potential difference, and the slits SL are formed at portions having no potential difference.

FIG. 16B is another exemplary waveform diagram of a signal that is supplied to electrodes so as to cause the switching liquid crystal panel 20 to have the barrier lighting state illustrated in FIG. 15. In the example illustrated in FIG. 16B, the signal supplied to the first electrodes 211D to 211I and the auxiliary electrodes 212D to 212I takes a constant value of the reference potential Vo. On the other hand, the signal supplied to the second electrodes 221, the first electrodes 211A to 211C, 211J to 211L, and the auxiliary electrodes 212A to 212C, 212J to 212L has a rectangular waveform taking two values of V₀+Vₐ and V₀−Vₐ.

In this example, a potential difference of |Vₐ| is formed between the second electrodes 221 and the first electrodes 211D to 211I, and between the second electrodes 221 and the auxiliary electrodes 212D to 222I. On the other hand, a potential difference of approximately zero is formed between the second electrodes 221 and the first electrodes 211A to 211C, 211J to 211L, and between the second electrodes 221 and the auxiliary electrodes 212A to 212C, 212J to 212L.

FIG. 16C is still another exemplary waveform diagram of a signal that is supplied to electrodes so as to cause the switching liquid crystal panel 20 to have the barrier lighting state illustrated in FIG. 15. In the example illustrated in FIG. 16C, a signal supplied to the second electrodes 221, the first electrodes 211A to 211C, 211J to 211L and the auxiliary electrodes 212A to 212C, 212J to 212L takes a constant value of the reference potential V₀. On the other hand, a signal supplied to the first electrodes 211D to 211I and the auxiliary electrodes 212D to 212I has a rectangular waveform having two values of V₀+Vₐ and V₀−Vₐ.

In this example as well, a potential difference of |Vₐ| is formed between the second electrodes 221 and the first electrodes 211D to 211I, and between the second electrodes 221 and the auxiliary electrodes 212D to 212I. On the other hand, a potential difference of approximately zero is formed between the common electrodes 221 and the first electrodes 211A to 211C, 211J to 211L, and between the common electrodes 221 and the auxiliary electrodes 212A to 212C, 212J to 212L.

In this way, the control device 40 (FIG. 2) forms the barriers BR and the slits SL by controlling the potentials of the first electrodes 211A to 211L, the auxiliary electrodes 212A to 212L, and the second electrodes 221. According to the present embodiment, the barriers BR and the slits SL can be moved, with use of the electrode interval BP1 as a minimum unit of the movement.

### Landscape 3D Mode

FIG. 17 is a plan view illustrating a state where the x direction of the stereoscopic display device 1 is parallel with the horizontal direction. Here, the control device 40 (FIG. 2) drives the switching liquid crystal panel 20 in the landscape 3D mode. In the landscape 3D mode, the barriers and the slits are formed along the x direction. FIG. 18 is a cross-sectional view taken along line XVIII-XVIII in FIG. 17, the cross-sectional view schematically illustrating one of barrier lighting states to be displayed on the switching liquid crystal panel 20. In FIG. 18, the illustration of the polarizing plates and the like is omitted.

In the landscape 3D mode, an identical signal is input to all of the first electrodes 211A to 211L (FIG. 10) and the auxiliary electrodes 212A to 212L (FIG. 13). Here, therefore, these are referred to as the first electrodes 211 and the auxiliary electrodes 212, without distinctions being made among these.

The control device 40 (FIG. 2) forms electric fields in the liquid crystal layer 23 by controlling the potentials of the first electrodes 211, the auxiliary electrodes 212, and the second electrodes 221A to 221L, thereby forming the barriers BR and the slits SL. In the example illustrated in FIG. 18, the barriers BR are formed at positions that overlap the second electrodes 221D to 221I, and the slits SL are formed at positions that overlap the second electrodes 221A to 221C and 221J to 221L.

FIG. 19A to FIG. 19C are exemplary waveform diagram of a signal that is supplied to electrodes so as to cause the switching liquid crystal panel 20 to have the barrier lighting state illustrated in FIG. 18. In FIGS. 19A to 19C, “211, 212” indicates a waveform diagram of a signal supplied to the first electrodes 211 and the auxiliary electrodes 212. Similarly, “221A to 221C, 221J to 221L” indicates a waveform diagram of a signal supplied to the second electrodes 221A to 221C, 221J to 221L. “221D to 221I” indicates a waveform diagram of a signal supplied to the second electrodes 221D to 221I. Detailed descriptions of FIGS. 19A to 19C are omitted since they are identical to the detail descriptions for FIGS. 16A to 16C.

In this way, the control device 40 (FIG. 2) forms the barriers BR and the slits SL by controlling the potentials of the first electrodes 211, the auxiliary electrodes 212, and the second electrodes 221A to 221L. According to the present embodiment, the barriers BR and the slits SL can be moved, with use of the electrode interval BP2 as a minimum unit of the movement.

### Effects of Stereoscopic Display Device 1

First of all, the crosstalk is quantitatively defined, using FIG. 20. FIG. 20 illustrates angle characteristics of luminance of the stereoscopic display device when the barrier lighting state is fixed. Luminance A_{L} is luminance observed at an angle θ of less than 0 (θ<0) when a black image is displayed as the right-eye image and a white image is displayed as the left-eye image. Luminance A_{R} is luminance observed at an angle θ of more than 0 (θ>0) on the same screen. Luminance B_{L} is luminance observed at an angle θ of less than 0 (θ<0) when a white image is displayed as the right-eye image, and a black image is displayed as the left-eye image. Luminance B_{R} is luminance observed at an angle θ of more than 0 (θ>0) on the same screen. Luminance C_{L} is luminance observed at an angle θ of less than 0 (θ<0) when black images are displayed as both of the right-eye image and the left-eye image. Luminance C_{R} is luminance observed at an angle θ of more than 0 (θ>0) on the same screen.

Here, crosstalk XT(L) for the left eye is defined by the following expression:

$$XT ( L ) [ \% ] = \frac{{B}_{L} ( θ ) - {C}_{L} ( θ )}{{A}_{L} ( θ ) - {C}_{L} ( θ )} \times 100 \qquad [ Formula 1 ]$$

Similarly, crosstalk XT(R) for the right eye is defined by the following expression:

$$XT ( R ) [ \% ] = \frac{{A}_{R} ( θ ) - {C}_{R} ( θ )}{{B}_{R} ( θ ) - {C}_{R} ( θ )} \times 100 \qquad [ Formula 2 ]$$

FIG. 21 illustrates angle characteristics of crosstalk XT(L) for the left eye and crosstalk XT(R) for the right eye. The crosstalk XT(L) for the left eye has a minimum value XT_{MIN}(L) at an angle −θ₀, and increases as deviation from the angle −θ₀ increases. Similarly, the crosstalk XT(R) for the right eye has a minimum value XT_{MIN}(R) at an angle +θ₀, and increases as deviation from the angle +θ₀ increases.

According to the present embodiment, the barriers BR and the slits SL are formed by controlling the potential of the auxiliary electrodes 212, in addition to the potentials of the first electrodes 211 and the second electrodes 221. With this configuration, it is possible to decrease crosstalk in both of the portrait 3D mode and the landscape 3D mode, as is described below.

FIG. 22 is a schematic cross-sectional view illustrating a configuration of a stereoscopic display device 90 according to a virtual comparative example, for explaining the effects of the present embodiment. The stereoscopic display device 90 includes a switching liquid crystal panel 91, in place of the switching liquid crystal panel 20 of the stereoscopic display device 1. The switching liquid crystal panel 91 has the same configuration as the configuration of the switching liquid crystal panel 20 except that no auxiliary electrode 212 is provided.

As illustrated in FIG. 22, the switching liquid crystal panel 91 is not capable of forming sufficient electric fields in areas between the first electrodes 211 (inter-line areas). This leads to unsatisfactory formation of the barriers BR in the inter-line areas, thereby causing light leakage in some cases.

As illustrated in FIG. 23, with the stereoscopic display device 1, it is possible to form electric fields in the areas between the first electrodes 211A to 211L, by means of the auxiliary electrodes 212. This enables to form the barriers BR in inter-line areas as well.

FIG. 24 schematically illustrates a state of barriers in the portrait 3D mode in the stereoscopic display device 90. In FIG. 24, parts where light is blocked are indicated by hatching. This applies to FIGS. 25 to 27, 32, and 33 to be described below. In the case of the stereoscopic display device 90, light leakage occurs, not only through the clearances between the second electrodes 221, but also the clearances between the first electrodes 211.

FIG. 25 schematically illustrates a state of barriers in the portrait 3D mode in the stereoscopic display device 1. In the case of the stereoscopic display device 1, barriers can be formed in the clearances between the first electrodes 211 as well, by the auxiliary electrodes 212. This enables to reduce light leakage in the inter-line areas as compared with the stereoscopic display device 90, thereby decreasing crosstalk.

FIG. 26 schematically illustrates a state of barriers in the landscape 3D mode in the stereoscopic display device 90. FIG. 27 schematically illustrates a state of barriers in the landscape 3D mode in the stereoscopic display device 1. In the case of the landscape 3D mode, as is the case with the portrait 3D mode, according to the configuration of the stereoscopic display device 1, barriers can be formed in the clearances between the first electrodes 211 as well, by the auxiliary electrodes 212. This enables to reduce light leakage in the inter-line areas as compared with the stereoscopic display device 90, thereby decreasing crosstalk.

In the present embodiment, the subpixels 110r, 110g, and 110b are aligned along the y direction. In the present embodiment, the alignment direction of the subpixels 110r, 110g, and 110b, and the alignment direction of the auxiliary electrodes 212 coincide with each other. This configuration enables to suppress “color breakup” in the portrait 3D mode, as described below.

As illustrated in FIG. 22, in the case of the stereoscopic display device 90, light leakage from the inter-line areas causes deviation between the width W_{B} of the barriers BR and the interval PP of the pixels. Even slight deviation between the width W_{B} of the barriers BR and the interval PP of the pixels causes the subpixels 110r, 110g, and 110b to become out of balance. In some cases, this causes “color breakup” when the barriers BR are moved, which is such a phenomenon that colors are mixed, like iridescence.

FIG. 28 is a schematic cross-sectional view illustrating a configuration of a stereoscopic display device 92 according to another comparative example. The stereoscopic display device 92 includes a switching liquid crystal panel 93 in place of the switching liquid crystal panel 20 of the stereoscopic display device 1. The switching liquid crystal panel 93 has such a configuration that the first electrodes 211 are divided more finely. The control device of the stereoscopic display device 92 drives the switching liquid crystal panel 93 so that the width W_{B} of the barriers satisfies W_{B}≈PP/3.

In the case of the stereoscopic display device 92, color breakup can be suppressed, but since it is necessary to finely divide the first electrodes 211, the productivity deceases. Further, the optimal visibility distance in the portrait 3D mode and that in the landscape 3D mode are different. More specifically, the optimal visibility distance in the portrait 3D mode is three times the optimal visibility distance in the landscape 3D mode.

As illustrated in FIG. 23, in the case of the stereoscopic display device 1, light leakage through the inter-line areas can be prevented by the auxiliary electrode 212, whereby the width W_{B} of the barriers BR satisfies W_{B}=PP. This enables to suppress the occurrence of color breakup in the portrait 3D mode. Besides, in the display panel 10 in which the aspect ratio of the pixel 110 is 1:1, the optimal visibility distance in the portrait 3D mode and that in the landscape 3D mode can be the same.

So far, the configuration of the stereoscopic display device 1 according to Embodiment 1 of the present invention is described.

In the present embodiment, the stereoscopic display device 1 is configured so that BP1=BP2 is satisfies. The alignment interval BP1 of the first electrodes 211 and the alignment interval BP2 of the second electrodes 221 may be different from each other.

In the present embodiment, the width W of the first electrodes 211 is greater than the width Ws of the auxiliary electrodes 212. These electrodes have a greater electric resistance as the width thereof is smaller. In a case where the width W of the first electrodes 211 and the width Ws of the auxiliary electrodes 212 are set to be equal to each other, the width of the electrodes is too small, which possibly causes crosstalk to increase. It is therefore preferable that, as is the case with the present embodiment, the width W of the first electrodes 211 is set to be greater than the width Ws of the auxiliary electrodes 212, and the light shielding properties of the barriers are ensured with use of the first electrodes 211, while supplementary light shielding properties are provided by the auxiliary electrodes 212. A certain level of effects, however, can be achieved by setting the width W of the first electrodes 211 and the width Ws of the auxiliary electrodes 212 to the same width.

In the present embodiment, the configuration is such that BP1=W+Ws is satisfied. In other words, the first electrodes 211 and the auxiliary electrodes 212 are formed so as not to overlap when viewed in a plan view. With this configuration, the electric fields applied to the liquid crystal layer 23 can be made more uniform. Even in a case where the first electrodes 211 and the auxiliary electrodes 212 overlap in a plan view, however, the electric fields at the overlapping portions by the auxiliary electrodes 212 are blocked to some extent by the first electrodes 211, and hence, the configuration may be such that BP1<W+Ws is satisfied.

In the present embodiment, the auxiliary electrodes 212, the insulating film 213, and the first electrodes 211 are laminated in the stated order from the first substrate 21 side. In some cases, when the first electrodes 211, which are wider, are arranged on the liquid crystal layer 23 side, the influence of the insulating film 213 can be made smaller, and the light shielding properties can be increased. From the first substrate 21 side, however, the first electrodes 211, the insulating film 213, and the auxiliary electrodes 212 may be laminated in the stated order.

In the present embodiment, the auxiliary electrodes 212 are formed on the first substrate 10. The auxiliary electrodes, however, may be formed, not on the first substrate 10, but on the second substrate 20.

In the present embodiment, the alignment direction of the subpixels 110r, 110g, and 110b, and the alignment direction of the auxiliary electrodes 212 coincide with each other. With this configuration, as described above, the occurrence of “color breakup” can be suppressed in the portrait 3D mode. The alignment direction of the subpixels 110r, 110g, and 110b, and the alignment direction of the auxiliary electrodes 212, however, may be different. For example, the configuration may be such that the first electrodes 211 and the auxiliary electrodes 212 are aligned along the x direction, while the second electrodes 221 are aligned along the y direction. This configuration enables to reduce the luminance variation due to tracking in the landscape 3D mode.

### EMBODIMENT 2

FIG. 29 is an exploded perspective view schematically illustrating a configuration of a stereoscopic display device 2 according to Embodiment 2 of the present invention. The stereoscopic display device 2 includes a switching liquid crystal panel 50 in place of the switching liquid crystal panel 20 of the stereoscopic display device 1. The switching liquid crystal panel 50 includes a second substrate 52 in place of the second substrate 22 of the switching liquid crystal panel 20. Incidentally, in FIG. 29, the illustration of the liquid crystal layer 23, the polarizing plates 14, 15, 24, and the like is omitted. FIG. 30 is a cross-sectional view taken along line XXX-XXX in FIG. 29. FIG. 31 is a cross-sectional view taken along line XXXI-XXXI in FIG. 29.

The second substrate 52 further includes auxiliary electrodes (second auxiliary electrodes) 222 in addition to the second electrodes 221. In FIG. 29, the auxiliary electrodes 222 are hatched, to make the diagram clearer.

The auxiliary electrodes 222 are arranged along the x direction at intervals BP2, as is the case with the second electrodes 221. Each of the auxiliary electrodes 222 is formed so as to extend along the y direction. The auxiliary electrodes 222 are arranged between the second electrodes 221 when viewed in a plan view. Between the second electrodes 221 and the auxiliary electrodes 222, an insulating film 223 (a second insulating film, FIG. 30) is arranged, so that these electrodes are not short-circuited.

In other words, in the stereoscopic display device 2, auxiliary electrodes are formed on both of the first substrate 21 and the second substrate 52.

FIG. 32 schematically illustrates a state of barriers in the portrait 3D mode in the stereoscopic display device 2. In the case of the stereoscopic display device 2, barriers can be formed at the clearances between the second electrodes 221 by the auxiliary electrodes 222. This enables to further reduce light leakage through inter-line areas, as compared with the stereoscopic display device 1, thereby further decreasing crosstalk.

FIG. 33 schematically illustrates a state of barriers in the landscape 3D mode in the stereoscopic display device 2. According to the configuration of the stereoscopic display device 2, barriers can be formed at the clearances between the second electrode 221 by the auxiliary electrodes 222, in the case of the landscape 3D mode as well, as is the case with the portrait 3D mode. This enables to further reduce light leakage through the inter-line areas, as compared with the stereoscopic display device 1, thereby further decreasing crosstalk.

### OTHER EMBODIMENTS

The embodiments of the present invention are described above, but the present invention is not limited to the above-described embodiments. Various changes can be made within the scope of the invention. Besides, the embodiments can be implemented in appropriate combinations.

In the embodiments mentioned above, examples are described in which a liquid crystal display panel is used as the display panel 10. However, an organic EL (electroluminescence) panel, a MEMS (microelectromechanical system) panel, or a plasma display panel may be used in the place of the liquid crystal display panel.

In the foregoing description of the embodiments, a case where the aspect ratio of the pixel 110 of the display panel 10 is 1:1 is described. The aspect ratio of the pixel 110 of the display panel 10, however, does not have to be 1:1.

In the foregoing description of the embodiments, a case where the switching liquid crystal panel 20 or 50 is so-called normally white liquid crystal is described. The switching liquid crystal panel 20 or 50 may be so-called normally black liquid crystal whose transmittance is minimized when no voltage is applied to the liquid crystal layer 23.

In the foregoing description of the embodiments, a case where the switching liquid crystal panel 20 or 50 and the display panel 10 are stacked so that the switching liquid crystal panel 20 or 50 is on the viewer side is described. The switching liquid crystal panel 20 or 50 and the display panel 10, however, may be stacked so that the display panel 10 is on the viewer side.

1. A stereoscopic display device comprising:
a display panel;
a switching liquid crystal panel that is arranged so as to be stacked on the display panel;
a position sensor that acquires position information of a viewer; and
a control device that controls the switching liquid crystal panel,
wherein the switching liquid crystal panel includes:
a first substrate and a second substrate that are arranged so as to be opposed to each other;
a liquid crystal layer interposed between the first substrate and the second substrate;
a plurality of first electrodes formed on the first substrate, arranged along a first direction at first intervals;
a plurality of auxiliary electrodes formed on the first substrate, arranged along the first direction at the first intervals;
an insulating film that insulates the first electrodes and the auxiliary electrodes from each other; and
a plurality of second electrodes formed on the second substrate, arranged along a second direction that intersects with the first direction at second intervals;
wherein the auxiliary electrodes are arranged between the first electrodes, when viewed in a plan view, and
the control device includes a driving circuit that controls potentials of the first electrodes, the second electrodes, and the auxiliary electrodes, based on the position information.

2. The stereoscopic display device according to claim 1,
wherein the display panel includes a plurality of pixels arranged in matrix,
the control device causes the switching liquid crystal panel to display a parallax barrier in which transmitting regions and non-transmitting regions are formed in periodic fashion, in accordance with the position information, and
each width of the non-transmitting regions is equal to each interval of the pixels.

3. The stereoscopic display device according to claim 2,
wherein each of the pixels includes a plurality of subpixels that display colors different from one another, respectively, and
the subpixels are arranged along the first direction.

4. The stereoscopic display device according to claim 1,
wherein each width of the first electrodes is greater than each width of the auxiliary electrodes.

5. The stereoscopic display device according to claim 1,
wherein the first electrodes and the auxiliary electrodes are arranged so as not to overlap when viewed in a plan view.

6. The stereoscopic display device according to claim 1,
wherein the first electrodes are arranged on the second substrate side with respect to the auxiliary electrodes.

7. The stereoscopic display device according to claim 1,
wherein the switching liquid crystal panel further includes:
a plurality of second auxiliary electrodes formed on the second substrate, arranged along the second direction at the second intervals; and
a second insulating film that insulates the second electrodes and the second auxiliary electrodes from each other,
wherein the second auxiliary electrodes are arranged between the second electrodes, when viewed in a plan view.

8. The stereoscopic display device according to claim 1,
wherein the display panel is a liquid crystal display panel.
